(19) United States
(12) Patent Application Publication
(10) Pub. No.: US 2010/0171072 A1
(43) Pub. Date: Jul. 8, 2010

(54) METHOD FOR MANUFACTURING GRANULAR METALLIC IRON

(75) Inventors: Takahiro Kudo, Hyogo (JP); Kazutaka Kunii, Hyogo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Kobe Seiko Sho (Kobe Steel, Ltd.), Kobe-shi, Hyogo (JP)

(21) Appl. No.: 12/666,729

(22) PCT Filed: Jun. 9, 2008
(86) PCT No.: PCT/JP08/60530

§ 371 Date: Dec. 24, 2009

(30) Foreign Application Priority Data
Jun. 27, 2007 (JP) 2007-169627
Jun. 27, 2007 (JP) 2007-169628
Jun. 27, 2007 (JP) 2007-169629

(51) Int. Cl. C09K 3/00; B22F 9/20

(52) U.S. Cl. 252/182.32; 75/343

(57) ABSTRACT

A method for manufacturing granular metallic iron includes charging a raw-material mixture into a thermal reduction furnace, subjecting the raw-material mixture to thermal reduction to form metallic iron and slag as a by-product, causing metallic iron to coalesce into granules while separating metallic iron from slag, and cooling and solidifying metallic iron. The raw-material mixture contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O, the alkali oxide satisfies at least one of Li₂O content≧0.03%, Na₂O content≧0.10%, and K₂O content≧0.10%, and the basicity of the slag is in the range of 1.3 to 2.3. It is possible to manufacture high-quality granular metallic iron with good productivity by the method.

### TECHNICAL FIELD

The present invention relates to a method for manufacturing granular metallic iron, and more particularly, to a method for manufacturing granular metallic iron by heating a raw-material mixture that contains an iron oxide-containing substance and a carbonaceous reductant in a thermal reduction furnace for direct reduction.

### BACKGROUND ART

A blast furnace iron-making process has been mainly used as a process of manufacturing iron from an iron oxide-containing material such as iron ore or iron oxide. A relatively small-scale direct reduction iron-making process suited to produce small batches and a variety of products has been developed and is receiving attention.

In the direct reduction iron-making process, a raw-material mixture containing an iron oxide-containing material and a carbonaceous reductant such as coal or coke (hereinafter, also referred to as a “carbon material”) (alternatively, a simple compact of the mixture or a carbon material-containing compact of the mixture, the carbon material-containing compact being in the form of a pellet or briquette) is first produced. Next, the raw-material mixture is placed on the hearth of a thermal reduction furnace (a moving-hearth thermal reduction furnace such as a rotary hearth furnace). The mixture is heated by heat and radiant heat from a heating burner while being moved in the furnace, so that iron oxide in the raw-material mixture is directly reduced by the carbonaceous reductant to form metallic iron (reduced iron). Reduced iron is carburized and melted. Then reduced iron coalesces into granules while being separated from slag formed as a by-product. Reduced iron is cooled and solidified. In this way, granular metallic iron (reduced iron) is obtained (for example, Patent Documents 1 to 3).

The direct reduction iron-making process does not require large-scale facilities such as a blast furnace and has been intensively studied in order to achieve practical use. To perform on an industrial scale, however, there are many problems regarding quality, productivity, stable operation, cost, safety, and the like of granular metallic iron (product) to be solved.

One of the challenges is to prevent inevitable sulfur contamination originating from coal having a high sulfur content when coal, which is the most versatile material as a carbonaceous reductant, is used.

The inventors have found that when a raw-material mixture containing coal as a carbonaceous reductant is thermally reduced, about 70% by mass or more of sulfur contained in coal is incorporated into granular metallic iron formed by thermal reduction. In some cases, the sulfur content of the granular metallic iron (hereinafter, the sulfur content of the granular metallic iron is also referred to as “[S]”, and the sulfur content of slag is also referred to as “(S)”) reaches 0.1% by mass or more and 0.2% by mass or more, depending on the grade of coal used (hereinafter, the units “% by mass” of the content are also abbreviated as “%”). If metallic iron has such a high sulfur content, the value of products is significantly reduced, and applications are also significantly limited. In the case where granular metallic iron produced by the direct reduction iron-making process is fed to existing steel-making facilities, such as electric furnaces and converters, and used as an iron source, the sulfur content of granular metallic iron is desirably minimized.

As a method for reducing the sulfur content of granular metallic iron produced by the direct reduction iron-making process, Patent Document 4 discloses appropriate control of basicity ((CaO)/(SiO₂)) determined from the CaO content and the SiO₂ content of slag that is a by-product formed when metallic iron is melted, where (CaO) and (SiO₂) represent the CaO content and the SiO₂ content of the slag, respectively. Furthermore, Patent Document 5 discloses that the basicity (([CaO]+[MgO])/[SiO₂]) of a slag-constituting component calculated from the CaO content, the MgO content, and the SiO₂ content of a raw-material mixture is set in the range of 1.3 to 2.3 and that the MgO content of the slag-constituting component is appropriately controlled, where [CaO], [MgO], and [SiO₂] represent the CaO content, the MgO content, and the SiO₂ content of the raw-material mixture, respectively.

Patent Document 5 also discloses the following: (i) a basicity (((CaO)+(MgO))/(SiO₂)) of the final slag of 1.7 or more results in a reduction in flowability as the basicity of the slag is increased, thereby significantly reducing the coalescing ability of reduced iron fine particles formed by reduction of an iron oxide-containing material in the raw-material mixture; (ii) large-grain metallic iron cannot be stably produced in high yield because of a reduction in coalescing ability; (iii) the addition of a CaF₂-containing material (e.g., fluorite) suffices to increase the yield, where (MgO) represents the MgO content of the slag.

### [Patent Document 1] Japanese Unexamined Patent Application Publication No. 2-228411

### [Patent Document 2] Japanese Unexamined Patent Application Publication No. 2001-279313

### [Patent Document 3] Japanese Unexamined Patent Application Publication No. 2001-247920

### [Patent Document 4] Japanese Unexamined Patent Application Publication No. 2001-279315

### [Patent Document 5] Japanese Unexamined Patent Application Publication No. 2004-285399

### DISCLOSURE OF INVENTION

The present invention has been made in light of the foregoing circumstances. It is an object of the present invention to provide a method for manufacturing granular metallic iron having a low sulfur content with good productivity, the method being different from the methods described above. It is another object of the present invention to provide slag as a by-product formed by the manufacturing method.

According to an aspect of the present invention, a method for manufacturing granular metallic iron includes the steps of:

charging a raw-material mixture that contains an iron oxide-containing material, a carbonaceous reductant, and an alkali metal compound into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron,

in which the raw-material mixture contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O,

the alkali oxide satisfies at least one of expressions (1) to (3) described below, and the basicity of the slag satisfies expression (4) described below.

(Li₂O)≧0.03 (1)

(Na₂O)≧0.10 (2)

(K₂O)≧0.10 (3)

1.3≦((CaO)+(MgO))/(SiO₂)≦2.3 (4)

where in expressions (1) to (4), (Li₂O), (Na₂O), (K₂O), (CaO), (MgO), and (SiO₂) represent proportions (% by mass) of Li₂O, Na₂O, K₂O, CaO, MgO, and SiO₂ in the slag, respectively.

According to another aspect of the present invention, a method for manufacturing granular metallic iron includes the steps of:

charging an alkali metal compound and a raw-material mixture that contains an iron oxide-containing material and a carbonaceous reductant into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron,

in which the raw-material mixture or the alkali metal compound contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O,

the alkali oxide satisfies at least one of expressions (1) to (3) described above, and the basicity of the slag satisfies expression (4) described above.

According to another aspect of the present invention, a method for manufacturing granular metallic iron includes the steps of charging a raw-material mixture that contains an iron oxide-containing material and a carbonaceous reductant into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron,

in which the raw-material mixture contains at least contains at least Fe, Ca, Mg, and Si as constituent elements in such a manner that

the slag contains CaO, MgO, and SiO₂, the basicity of the slag satisfies expression (5) described below, and the MgO content of the slag satisfies expression (6) described below.

1.5≧((CaO)+(MgO))/(SiO₂)≧2.2 (5)

13<(MgO)≧25 (6)

where in expressions (5) and (6), (CaO), (MgO), and (SiO₂) represent proportions (% by mass) of CaO, MgO, and SiO₂ in the slag, respectively.

According to another aspect of the present invention, slag formed as a by-product by the manufacturing methods described above.

The objects, features, aspects, and advantages of the present invention will be more apparent from the following detailed description and attached drawings.

### BRIEF DESCRIPTION OF DRAWINGS

FIG. 1 is a schematic explanatory view showing an example of a rotary hearth thermal reduction furnace.

FIG. 2 is a graph showing the relationship between the basicity of slag and the distribution ratio of sulfur in Example a.

FIG. 3 is a graph showing the relationship between the basicity of slag and the distribution ratio of sulfur in Example b.

FIG. 4 is a graph showing the relationship between the basicity of slag and the distribution ratio of sulfur in Example c.

FIG. 5 is a graph showing the relationship between the MgO content of slag and the distribution ratio of sulfur in Example c.

### BEST MODES FOR CARRYING OUT THE INVENTION

### First Embodiment

A first embodiment of the present invention will be described below.

In a direct reduction iron-making process, a large-sized rotary hearth thermal reduction furnace is typically used as a commercial thermal reduction furnace. In the rotary hearth thermal reduction furnace, a fuel gas such as natural gas is burnt with a plurality of burners arranged above a rotary hearth. The resulting heat of combustion is supplied to a raw-material mixture placed on the hearth and serves as heat required for smelting reduction. An exhaust gas generated by combustion contains oxidizing gases such as CO₂ and H₂O. The oxidizing gases affect the composition of an atmospheric gas around the raw-material mixture. Thus, it is very difficult to maintain the reduction potential of the atmospheric gas in the furnace at a high level unless the oxidizing gases are appropriately removed. Meanwhile, in the case where the reduction potential of the atmospheric gas in or around the raw-material mixture is sufficiently high, sulfur contained in a carbonaceous reductant, such as coal or coke, incorporated into the raw-material mixture is fixed in the form of CaS owing to CaO in slag. CaS is separated from the raw-material mixture together with the slag. The incorporation of a fluorine-containing substance, such as fluorite (CaF₂), into the raw-material mixture results in further separation of sulfur in the raw-material mixture from the raw-material mixture.

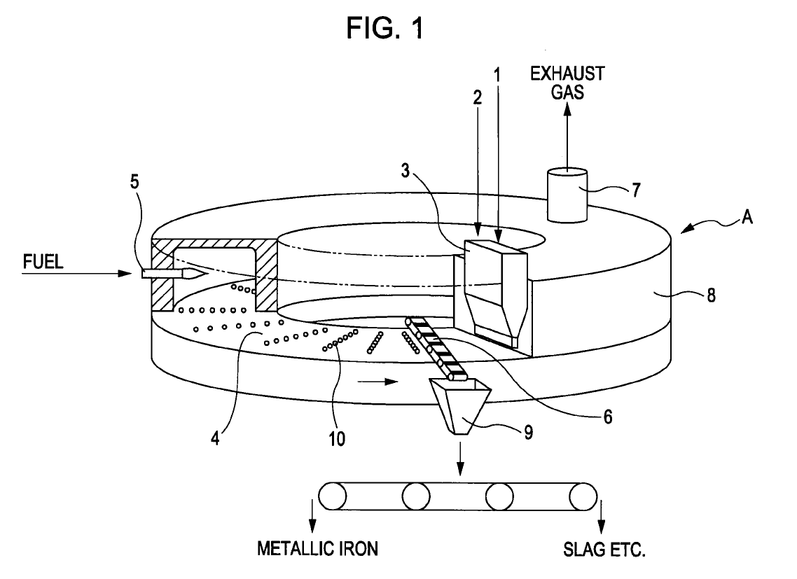

With respect to a method for removing the oxidizing gases, a layer of a carbonaceous powder (hereinafter, referred to as a “bed layer”), not shown, is formed in advance on a hearth of a thermal reduction furnace A shown in FIG. 1. A raw-material mixture is placed on the bed layer and subjected to thermal reduction. A target smelting reduction reaction is allowed to proceed efficiently while the hearth of the rotary hearth thermal reduction furnace is rotated with a cycle period of about 8 to about 16 minutes. The reduction potential of the atmospheric gas in the vicinity of the raw-material mixture can be maintained at a high level. Furthermore, the ability of desulfurization can be relatively increased.

However, the inventors have found that only the foregoing operation of forming the bed layer is still insufficient to assuredly produce granular metallic iron having a low sulfur content in a practical-scale rotary hearth thermal reduction furnace. According to the methods disclosed in Patent Documents 4 and 5 described above, granular metallic iron having a lower sulfur content can be more assuredly produced. These methods according to these patent documents focus on the basicity of slag. The reason for this is summarized below.

To reduce the sulfur content [S] of granular metallic iron (that is, to increase the apparent desulfurization rate), it is extremely important to stably keep the sulfur content (S) of slag while sulfur is fixed in the form of CaS in slag and to prevent migration of sulfur toward reduced iron. Specifically, it is necessary to maintain the reduction potential of the atmospheric gas at a high level and to maximize the basicity of the final slag. Unlike a conventional iron- or steel-making furnace where molten iron is used, in the smelting reduction process as the object of the present invention, an atmospheric temperature exceeding 1550° C. is not preferred from the viewpoint of the equipment and operation of the moving-hearth thermal reduction furnace. Operation is desirable while maintaining the atmospheric temperature at about 1550° C. or lower and preferably 1500° C. or lower. In the case where the basicity of the slag formed in the smelting reduction step is increased to more than about 1.7 under the temperature condition, however, the melting point of the slag is increased to inhibit the coalescence of the slag. Furthermore, the coalescence of reduced iron is also inhibited. This leads to difficulty in manufacturing large-grain metallic iron in high yield.

The inventors have conducted intensive studies in order that slag-forming components are melted as soon as possible to form slag when a raw-material mixture placed in a moving-hearth thermal reduction furnace is heated, and then the resulting slag is allowed to coalesce to promote the coalescence of remaining reduced iron, thereby increasing the productivity of granular metallic iron, and in order to reduce the proportion of sulfur with which granular metallic iron produced by such a process is inevitably contaminated.

From the studies, it was found that in the case where a raw-material mixture contains at least Fe, Ca, Mg, Si, and an alkali metal as constituent elements in such a manner that slag contains CaO, MgO, SiO₂, and an alkali oxide, the alkali oxide is at least one selected from Li₂O, Na₂O, and K₂O, the alkali oxide satisfies at least one of expressions (1) to (3) described above, and the basicity of the slag satisfies expression (4) described above, the distribution ratio of sulfur between the final slag and the final granular metallic iron, i.e., (S)/[S], is significantly improved to markedly reduce the sulfur content [S] of granular metallic iron, so that granular metallic iron having a low sulfur content can be produced with good productivity. This has led to the completion of a method for manufacturing granular metallic iron according to the first embodiment. The method for manufacturing granular metallic iron according to the first embodiment and slag formed as a by-product by the manufacturing method will be described in detail below.

### [Constituent of Slag]

Slag formed by a conventional direct reduction iron-making process contains CaO, MgO, and SiO₂ as its constituents. The basicity of the slag (((CaO)+(MgO))/(SiO₂)) is determined by proportions of these constituents. The basicity of the slag is closely related to the distribution ratio of sulfur, (S)/[S], in a slag-metal reaction in a common iron- and steel-making process.

Meanwhile, slag formed in this embodiment also contains an alkali oxide as its constituent. The slag containing the alkali oxide in addition to CaO, MgO, and SiO₂ provides a desulfurization effect superior to a conventional slag containing CaO, MgO, and SiO₂.

The reason why the slag containing the alkali oxide in addition to CaO, MgO, and SiO₂ provides an excellent desulfurization effect remains to be theoretically elucidated. However, from experimental results described below, the reason is inferred as follows. That is, it is inferred that appropriate control of the basicity of slag formed as a by-product in manufacturing granular metallic iron and appropriate control of the alkali oxide content of the slag results in a reduction in the melting point of the slag as a by-product, the optimization of physical properties such as flowability of the slag, and the maximization of the distribution ratio of sulfur, (S)/[S], for the slag as a by-product.

The type of alkali oxide in the slag is not particularly limited. In the case where the alkali oxide is Na₂O, K₂O, or Li₂O, the alkali oxide significantly affects the lowering of the melting point of the slag. Thus, the alkali oxide may be at least one selected from the group consisting of Na₂O, K₂O, and Li₂O.

### [Li₂O Content, Na₂O Content, and K₂O Content of Slag]

The desulfurization effect is provided at an alkali oxide content of slag of about 0.03% by mass when the alkali oxide is Li₂O, about 0.10% by mass when the alkali oxide is Na₂O, or about 0.10% by mass when the alkali oxide is K₂O. The Li₂O content of formed slag is preferably 0.1% by mass or more and more preferably 0.3% by mass or more. The Na₂O content of formed slag is preferably 0.2% by mass or more and more preferably 0.5% by mass. The K₂O content of formed slag is preferably 0.3% by mass or more and more preferably 0.7% by mass.

The upper limit of the Li₂O content of formed slag is preferably 12% by mass. The upper limit of the Na₂O content is preferably 5% by mass. The upper limit of the K₂O content is preferably 5% by mass. The active incorporation of Li₂O, Na₂O, or K₂O into slag formed results in a reduction in the melting point of the formed slag as a by-product and an increase in the distribution ratio of sulfur in the slag. However, an excessively higher Li₂O content, Na₂O content, or K₂O content of slag causes vigorous evaporation of Li₂O, Na₂O, or K₂O, so that evaporated Li₂O, Na₂O, or K₂O reacts with refractories in the furnace, promoting damage to furnace walls. The Li₂O content is preferably 11% by mass or less and more preferably 10% by mass or less. The Na₂O content is preferably 4.5% by mass or less and more preferably 4% by mass or less. The K₂O content is preferably 3% by mass or less and more preferably 2% by mass or less. Slag may contain Li₂O, Na₂O, or K₂O alone or in combination of two or more.

### [Alkali Metal Compound]

The alkali metal compound according to this embodiment may be at least one compound selected from the group consisting of lithium compounds, sodium compounds, and potassium compounds. That is, the alkali metal compound according to this embodiment may be a lithium compound, a sodium compound, or a potassium compound. Alternatively, the alkali metal compound according to this embodiment may be a combination of two or more compounds selected from the group consisting of lithium compounds, sodium compounds, and potassium compounds. Furthermore, the alkali metal compound according to this embodiment may also be a combination of any one of “lithium compounds, sodium compounds, and potassium compounds” and an alkali metal compound other than “lithium compounds, sodium compounds, or potassium compounds”.

The raw-material mixture may contain at least one compound selected from the group consisting of lithium compounds, sodium compounds, and potassium compounds as the alkali metal compound in such a manner that the alkali oxide in the slag satisfies at least one of expressions (1) to (3) described above. Thus, the raw-material mixture may contain the alkali metal compound in such a manner that the slag contains an alkali oxide other than “Li₂O, Na₂O, or K₂O”.

The type of the lithium compound is not particularly limited. Examples thereof include lithium carbonate (Li₂CO₃) and lithium oxide (Li₂O).

The type of the sodium compound is not particularly limited. Examples thereof include sodium carbonate (Na₂CO₃) and sodium oxide (Na₂O).

The type of the potassium compound is not particularly limited. Examples thereof include potassium carbonate (K₂CO₃) and potassium oxide (K₂O).

The alkali metal compound may be a compound that forms any two or more of Li₂O, Na₂O, and K₂O in the slag. An example of an M1-M2-based complex oxide in which an oxide of an alkali metal (M1) is simply mixed with an oxide of an element (M2) other than alkali metals is Na₂O—Li₂O—SiO₂—CaO. An example of an alkali metal compound that forms Na₂O and K₂O in the slag is nepheline [composition: (Na,K)(Al,Si)O₄]. Note that nepheline also corresponds to a “complex oxide having a melting point of 1400° C. or lower and containing an alkali metal” described below.

The alkali metal compound is preferably a complex oxide having a melting point of 1400° C. or lower and containing at least one alkali metal. As described above, a moving-hearth thermal reduction furnace is typically operated while a temperature in the furnace (atmospheric temperature) is maintained at about 1450° C. to about 1550° C. Thus, heating a raw-material mixture containing a complex oxide having a melting point of 1400° C. or lower in the moving-hearth thermal reduction furnace results in quick melting of the complex oxide. The coalescence of this results in the rapid formation of slag. The rapid formation of the slag promotes coalescence of remaining metallic iron into granules, thereby improving the productivity of granular metallic iron. That is, the incorporation (external addition) of the complex oxide having a low melting point into the raw-material mixture results in quick melting of the complex oxide by application of heat to form a premelting state, thereby improving the productivity of granular metallic iron. As described in Example b below, the use of the complex oxide as the alkali metal compound results in reductions not only in the sulfur content of metallic iron but also in time required for melting the raw-material mixture compared with the use of a single oxide of an alkali metal (alkali oxide), hereby further increasing the productivity.

Examples of the alkali metal in the complex oxide include Li, Na, and K. Li and Na are preferably used from the viewpoint of easy availability. The complex oxide described above may contain at least one alkali metal. For example, the complex oxide preferably contains at least one of Li, Na, and K.

The term “the complex oxide containing at least one alkali metal” is used to indicate an oxide containing at least one selected from the group consisting of alkali metal elements and containing at least one element other than alkali metals on the basis of the analysis of a component composition by, for example, ICP spectrometry or atomic absorption spectrophotometry. Specifically, when the component composition of the oxide is analyzed by, for example, ICP spectrometry or atomic absorption spectrophotometry, at least one alkali metal and another element other than alkali metals are detected. The complex oxide contains an alkali oxide (e.g., Na₂O, Li₂O, or K₂O) and an oxide of another element (e.g., an oxide of a slag-constituting component) other than alkali metals when each of the detected elements is assumed to be in the form of a single oxide. That is, the complex oxide may contain at least one selected from the group consisting of Na₂O, Li₂O, and K₂O and at least one selected from the group consisting of MgO, CaO, BaO, MnO, FeO, B₂O₃, Al₂O₃, and SiO₂.

The complex oxide may be produced as follows: First, an “alkali metal-supplying material” is mixed with a “material that supplies another element other than alkali metals”. Then the resulting mixture is fired. Alternatively, the mixture is melted and solidified. The resulting complex oxide may be pulverized to adjust the particle size, as needed.

Examples of the “alkali metal-supplying material” include sodium carbonate (Na₂CO₃) for a Na-supplying material; potassium carbonate (K₂CO₃) for a K-supplying material; and lithium carbonate (Li₂CO₃) for a Li-supplying material.

Examples of the “material that supplies another element other than alkali metals” are described below.

Examples thereof include SiO₂ for a Si-supplying material; quick lime (CaO) and calcium carbonate (CaCO₃) for a Ca-supplying material; MgO and MgCO₃ for a Mg-supplying material; BaCO₃ for a Ba-supplying material; MnCO₃ for a Mn-supplying material; FeO for an Fe-supplying material; H₃BO₃ for a B-supplying material; and Al₂O₃ for an Al-supplying material. These materials usually contain incidental impurities.

An example of a material that supplies Na, K, and Si is nepheline [composition: (Na,K)(Al,Si)O₄].

The complex oxide described above may further contain another element as long as another element does not increase the melting point of the complex oxide to more than 1400° C. However, in the M1-M2-based complex oxide, the effect of reducing a melting time is not provided because when the M1 oxide is simply mixed with the M2 oxide, the melting point of the resulting mixture is not reduced to 1400° C. or lower.

The raw-material mixture may contain the “complex oxide having a melting point of 1400° C. or lower and containing at least one alkali metal” and a “single compound of an alkali metal” as the alkali metal compound. Examples of the “single compound of an alkali metal” include alkali oxides and carbonates of alkali metals.

In the case of using the “complex oxide having a melting point of 1400° C. or less and containing at least one alkali metal” as the alkali metal compound, the complex oxide may be added to the raw-material mixture in such a manner that the total proportion of the single oxides is 0.03% by mass or more, preferably 0.05% by mass or more, and more preferably 0.2% by mass or more when alkali metal elements in the slag are assumed to be in the form of single oxides.

Furthermore, in the case of using the “complex oxide having a melting point of 1400° C. or less and containing at least one alkali metal” as the alkali metal compound, the complex oxide may be added to the raw-material mixture in such a manner that the total proportion of the single oxides is 15% by mass or less, preferably 14.5% by mass or less, and more preferably 13% by mass or less when alkali metal elements in the slag are assumed to be in the form of single oxides. The reason for this is as follows: As described above, the active incorporation of the alkali oxide into slag formed results in a reduction in the melting point of the formed slag as a by-product and an increase in the distribution ratio of sulfur in the slag. However, an excessively higher alkali oxide content causes excessively vigorous evaporation of the alkali metal in the furnace, so that the evaporated alkali metal reacts with refractories in the furnace, promoting damage to the refractories.

The fact that the alkali metal elements are assumed to be in the form of single oxides indicates that when an alkali metal element is represented by M1, an oxide of the alkali metal element contained in the slag is represented by the formula M1₂O.

Proportions of the single oxides of the alkali metal elements in the slag may be adjusted by adjusting the amount of the complex oxide added in response to the composition of the complex oxide added to the raw-material mixture. That is, the adjustment of the amount of the complex oxide added to the raw-material mixture in response to the composition of the complex oxide containing at least one element selected from the group consisting of alkali metal elements adjusts the alkali oxide content of the slag.

### [Basicity of Slag: 1.3 to 2.3]

The basicity of the slag, (((CaO)+(MgO))/(SiO₂)), is set in the range of 1.3 to 2.3. A higher proportion of a CaO/MgO-supplying material, which serves as a basicity-adjusting agent, (a material that forms CaO and MgO in the slag), such as limestone or dolomite ore, in the raw-material mixture results in increases in the CaO content and the MgO content of the final slag, thereby increasing the slag basicity. An excessive incorporation of the CaO/MgO-supplying material results in slag having a basicity exceeding 2.3. However, an excessively high slag basicity causes an increase in the viscosity (flowability) of the slag, inhibiting the coalescence of reduced iron and thus leading to difficulty in providing granular metallic iron preferably having a roughly spherical shape. Furthermore, the yield of the granular metallic iron tends to be decreased. Thus, the upper limit of the slag basicity is determined to be 2.3. The slag basicity is preferably 2.2 or less and more preferably 2.0 or less. Note that a higher slag basicity results in a lower melting point of the final slag.

Meanwhile, a slag basicity of less than 1.4 causes a reduction in the desulfurization ability of the slag, so that the intended purpose is not achieved even when the reduction potential of the atmosphere is maintained at a sufficiently high level. Thus, the lower limit of the slag basicity is determined to be 1.4. The slag basicity is preferably 1.5 or more.

In this specification, the “slag basicity” is used to indicate the ratio of (CaO)+(MgO) to (SiO₂), i.e., ((CaO)+(MgO))/(SiO₂), determined from proportions of CaO, MgO, and SiO₂ in the slag, unless otherwise specified.

### [MgO Content of Slag: 5% to 22% by Mass]

In this embodiment, the slag preferably has a MgO content of 5% by mass or more. This is because even if the slag basicity of 2.3 or less, basically, the coalescing ability of reduced iron fine particles formed by reduction of the iron oxide-containing material in the raw-material mixture is gradually reduced with increasing basicity in a relatively high basicity region having a basicity of 1.9 or more. That is, in a relatively high basicity region, the coalescing ability of the slag is significantly reduced, and the coalescing ability of reduced iron particles formed is also reduced, thereby leading to difficulty in manufacturing large-grain metallic iron intended in this embodiment in high yield. Thus, in a relatively high basicity region, even if the final slag has a basicity of 2.3 or less, the slag preferably has a MgO content of 5% by mass or more from the viewpoint of ensuring economical operation in this embodiment. This is because a MgO content of the slag of less than 5% by mass results in crystallization of a complex oxide represented by 2CaO.SiO₂ in the slag at a usual operation temperature, thereby causing loss of the flowability of the slag and loss of the coalescing ability. On the other hand, in a relatively high slag basicity of 1.9 or more, a MgO content of the slag exceeding 22% by mass causes crystallization of MgO in the slag, thereby inhibiting the coalescing ability. Thus, target large-grain metallic iron cannot be manufactured in high yield. Therefore, the slag preferably has a MgO content of 22% by mass or less. More preferably, the slag preferably has a MgO content of 20% by mass or less.

The basicity of the slag and the MgO content of the slag can be controlled by adjusting the amounts of the iron oxide-containing material and the carbonaceous reductant added. This is because the iron oxide-containing material and the carbonaceous reductant contain at least CaO, MgO, and SiO₂. Iron ore added as the iron oxide-containing material and coal or coke added as the carbonaceous reductant are natural products. Hence, proportions of CaO, MgO, and SiO₂ are different, depending on the types thereof. It is thus difficult to uniformly determine the amounts of these materials added. It is preferable to appropriately adjust the amounts of the iron oxide-containing material and the carbonaceous reductant in consideration of the component composition of gangue contained in, for example, iron ore added as the iron oxide-containing material and the component composition of ash contained in coal or coke added as the carbonaceous reductant.

The same is true for the amount of the complex oxide added. It is difficult to uniformly determine the amount of the complex oxide because the component composition is different, depending on the type of complex oxide. Thus, the amount of added may be appropriately adjusted in consideration of the component composition of the complex oxide.

For example, in the case of charging a carbonaceous powder used as a component of the bed layer, the basicity of the slag and the MgO content of the slag may be controlled by adjusting the amounts of the iron oxide-containing material and the carbonaceous reductant added in consideration of the component of the carbonaceous powder and the amount of the powder charged.

As described above, the main features of this embodiment are as follows: The formed slag contains the alkali oxide; and the Na₂O content, the K₂O content, the Li₂O content, and the basicity of the slag are specified. Accordingly, it is not always necessary to use the carbonaceous powder, serving as a component of the bed layer, placed on the hearth. However, the arrangement of the carbonaceous powder, serving as the component of the bed layer, on the hearth results in a more efficient increase in reduction potential in the furnace, so that both effects of improving metallization ratio and reducing the sulfur content [S] of metallic iron can be more effectively provided. To more assuredly provide such effects of the component of the bed layer, it is desirable to place a granular carbonaceous powder so as to form a layer having a thickness of about 2 mm or more. In the case where the carbonaceous powder is placed as the component of the bed layer in such a manner that the layer has a certain thickness, the bed layer serves as a buffer between the raw-material mixture and a hearth refractory or serves as a protector for protecting the hearth refractory from slag as a by-product, thereby serving to extend the life of the hearth refractory.

An excessively larger thickness of the bed layer, however, may disadvantageously cause inhibition of reduction by allowing the raw-material mixture to sink in the bed layer on the hearth. Thus, the thickness of the bed layer is preferably set to be about 7.5 mm or less.

The type of carbonaceous powder used as the component of the bed layer is not particularly limited. Crushed ordinary coal or coke may be used. Preferably, crushed ordinary coal or coke with a grain size that has been properly controlled may be used. In the case of using coal, anthracite, which has low flowability and does not expand or become sticky on the hearth, is suitable.

Iron ore serving as the iron oxide-containing material and coal serving as the carbonaceous reductant added to the raw-material mixture each correspond to a MgO-supplying material (a material that forms MgO in slag). A material other than the iron oxide-containing material, the carbonaceous reductant, or the alkali metal compound may be added as “another MgO-supplying material” to the raw-material mixture. The “another MgO-supplying material” corresponds to an external additive in the light of the iron oxide-containing material, the carbonaceous reductant, and the alkali metal compound. In this case, the amounts of the “another MgO-supplying material”, an oxide-containing material, the carbonaceous reductant, and the alkali metal compound added may be adjusted in consideration of the component compositions of the “another MgO-supplying material”, the oxide-containing material, the carbonaceous reductant, and the alkali metal compound in such a manner that the slag has a basicity of 1.3 to 2.3 and, as needed, a MgO content of 5% to 22% by mass.

The type of “another MgO-supplying material” is not particularly limited. Examples thereof include a MgO powder, natural ore, Mg-containing materials extracted from seawater and so forth, and magnesium carbonate (MgCO₃).

Each of iron ore serving as the iron oxide-containing material and coal serving as the carbonaceous reductant added to the raw-material mixture also correspond to a CaO-supplying material (a material that forms CaO in slag). A material other than the iron oxide-containing material, the carbonaceous reductant, or the alkali metal compound may be added as “another CaO-supplying material” to the raw-material mixture. The “another CaO-supplying material” corresponds to an external additive in the light of the iron oxide-containing material, the carbonaceous reductant, and the alkali metal compound. In this case, the amounts of the “another CaO-supplying material”, an oxide-containing material, the carbonaceous reductant, and the alkali metal compound added may be adjusted in consideration of the component compositions of the “another CaO-supplying material”, an oxide-containing material, the carbonaceous reductant, and the alkali metal compound in such a manner that the slag has a basicity of 1.3 to 2.3 and, as needed, the CaO content of the slag is in an appropriate range.

The type of “another CaO-supplying material” is not particularly limited. Examples thereof include quicklime (CaO) and calcium carbonate (CaCO₃).

For example, dolomite ore may be added as a CaO/MgO-supplying material to the raw-material mixture.

An addition method of the “another MgO-supplying material” and the “another CaO-supplying material” is not particularly limited. Instead of adding the “another MgO-supplying material” and the “another CaO-supplying material” to the raw-material mixture, the “another MgO-supplying material” and the “another CaO-supplying material” may be placed on a rotary hearth, in advance, together with or independent of a component of the bed layer. Alternatively, the “another MgO-supplying material” and the “another CaO-supplying material” may be charged simultaneously with the charging of the raw-material mixture or may be separately charged from above after the charging of the raw-material mixture.

The raw-material mixture may contain a small amount of polysaccharide (e.g., starch from flour) as a binder.

Preferably, fluorite is not added to the raw-material mixture from the viewpoint of “emphasis on environmental friendliness”. According to this embodiment described above, it is possible to sufficiently improve the desulfurization ability and the coalescing ability without adding fluorite. However, the addition of fluorite to the raw-material mixture can further improve the desulfurization ability and the coalescing ability.

In this embodiment, as described above, in the case of performing operation using a practical-scale rotary hearth thermal reduction furnace, when the basicity of the final slag is increased to up to about 2.3 with the MgO-supplying material serving as a basicity-adjusting material, the slag can be sufficiently melted in the temperature range up to 1450° C. in light of real operation. This enables granular metallic iron to be manufactured in stable operation. Furthermore, it is possible to ensure a distribution ratio of sulfur between the slag and the metal, (S)/[S], of about 10 or more and particularly 20 or more. As a result, although there are some differences depending on the grade of coal serving as the carbonaceous reductant, a component of the bed layer, and so forth, the sulfur content of the final granular metallic iron can be stably reduced to 0.080% or less and particularly 0.05% or less. In the case of using the “complex oxide having a melting point of 1400° C. or lower and containing at least one alkali metal” as the alkali metal compound, the sulfur content of the final granular metallic iron can be stably reduced to 0.05% or less and particularly 0.01% or less.

As described above, in the case of using the most versatile gas burners as a heating method of a commercial furnace, a reduction in the distribution ratio of sulfur, (S)/[S], due to a decrease in the reduction potential of the atmospheric gas cannot be avoided. In this embodiment, however, it is possible to prevent the reduction in the distribution ratio of sulfur, (S)/[S], because the alkali oxide (e.g., Li₂O, Na₂O, and K₂O) in the slag satisfies at least one expressions (1) to (3) described above and because the basicity of the slag satisfies expression (4) described above.

The outline of a moving-hearth thermal reduction furnace used in this embodiment, the outline of a method for manufacturing granular metallic iron using the thermal reduction furnace, and the mechanism for the production of granular metallic iron will be described in detail below with reference to FIG. 1. The drawings are not limited to this embodiment. These may be properly modified within the scope of the purposes described above and below. All such modifications are included in the technical scope of the present invention.

FIG. 1 is a schematic explanatory view showing a structural example of a rotary hearth thermal reduction furnace A among moving-hearth thermal reduction furnaces. To show the internal structure of the furnace, the furnace is partially cut out to illustrate the inside.

A raw-material mixture 1 containing an iron oxide-containing material, a carbonaceous reductant, and an alkali metal compound is continuously fed onto a rotary hearth 4 of the rotary hearth thermal reduction furnace A through a material feed hopper 3. Iron ore, magnetite ore, and so forth are commonly used as the iron oxide-containing material. Coal, coke, and so forth are commonly used as the carbonaceous reductant. Sodium carbonate, nepheline, and so forth are used as the alkali metal compound.

The shape of the raw-material mixture 1 supplied is not particularly limited. Typically, a simple compact of the raw-material mixture containing the iron oxide-containing material, the carbonaceous reductant, and the alkali metal compound is supplied. Alternatively, a carbon material-containing compact of the raw-material mixture in the form of a pellet or briquette is supplied. A mixture in which the iron oxide-containing material, the carbonaceous reductant, the alkali metal compound, and so forth are appropriately mixed may be supplied. Furthermore, granular carbonaceous powder 2 may be supplied together with the simple compact or the carbon material-containing compact.

A material (e.g., a MgO-supplying material or a CaO-supplying material) other than the raw-material mixture may be charged into the thermal reduction furnace A, as needed. Preferably, a fluorine-containing desulfurizing agent, however, is not charged from the viewpoint of emphasis on environmental friendliness.

A procedure for feeding the raw-material mixture 1 into the thermal reduction furnace A will be specifically described below. Preferably, the granular carbonaceous powder 2 is fed onto the rotary hearth 4 through the material feed hopper 3 to form a bed prior to the feed of the raw-material mixture 1, and then the raw-material mixture 1 is placed thereon.

FIG. 1 shows an example of one material feed hopper 3 that is used for both of the feed of the carbonaceous powder 2 and the feed of the raw-material mixture 1. Alternatively, the carbonaceous powder 2 and the raw-material mixture 1 may be separately charged using two or more hoppers. The carbonaceous powder 2 used for the formation of a bed is significantly effective not only in increasing reduction efficiency but also in promoting a reduction in the sulfur content of granular metallic iron produced by thermal reduction. However, the feed of the carbonaceous powder 2 may be omitted. The type of carbonaceous powder fed to form the bed is not particularly limited. Examples thereof include coal and coke. The carbonaceous powder fed to form the bed preferably has a lower sulfur content than the carbonaceous reductant added to the raw-material mixture.

The rotary hearth 4 of the thermal reduction furnace A shown in FIG. 1 is rotated counterclockwise. The rotation speed varies depending on the size and operation conditions of the thermal reduction furnace A. The rotary hearth typically has a cycle period of about 8 to about 16 minutes. A plurality of heating burners 5 are arranged on walls of a furnace body 8 of the thermal reduction furnace A. The hearth is supplied with heat resulting from combustion heat or radiant heat from the heating burners 5. The heating burners 5 may be arranged on a ceiling portion of the furnace.

The raw-material mixture 1 placed on the rotary hearth 4 constituted by a refractory material is heated by combustion heat or radiant heat from the heating burners 5 while being circumferentially moved on the rotary hearth 4 in the thermal reduction furnace A. Iron oxide in the raw-material mixture 1 is reduced while passing through a heating zone in the thermal reduction furnace A. Then reduced iron is subjected to carburization with the remaining carbonaceous reductant while being separated from molten slag formed as a by-product, and coalesce into granular metallic iron 10. The granular metallic iron 10 is solidified by cooling in a downstream zone of the rotary hearth 4 and then successively discharged from the hearth by a discharge device 6 such as a screw. At this time, the slag formed as a by-product is also discharged. The granular metallic iron 10 and the slag pass through a hopper 9 and then are separated into metallic iron and the slag with any separating means (e.g., a screen or a magnetic separator). In FIG. 1, reference numeral 7 denotes an exhaust gas duct.

In this embodiment, as described above, in the slag formed as a by-product by thermal reduction, the alkali oxide in the slag satisfies at least one of expressions (1) to (3) described above, and the basicity of the slag satisfies expression (4) described above. It is thus possible to suitably control the melting point of the formed slag and the distribution ratio of sulfur, (S)/[S], and to efficiently manufacture granular metallic iron having a low sulfur content.

### EXAMPLES

A method for manufacturing granular metallic iron according to this embodiment will be described in further detail below by examples. The present invention is not limited to these examples described below. These examples may be properly modified within the scope of the purposes described above and below. All such modifications are included in the technical scope of the present invention. In the following examples, the results of tests performed with a small experimental thermal reduction furnace are described.

### Example a

Iron ore was used as an iron oxide-containing material. Coal was used as a carbonaceous reductant. These were mixed to form a mixture M. Table 1 shows the component composition of iron ore. Table 2 shows the component composition of coal (others in analysis values indicates a carbonaceous solid).

TABLE 1
Component composition of iron ore (% by mass)

| T. Fe | FeO | SiO₂ | CaO | MgO | Al₂O₃ | S | P |
|---|---|---|---|---|---|---|---|
| 69.39 | 30.10 | 1.75 | 0.45 | 0.40 | 0.49 | 0.028 | 0.013 |

TABLE 2
Coal

| Analysis value (% by mass) | | | | Component composition of total ash | | | | |
|---|---|---|---|---|---|---|---|---|
| | Total | Sul- | Oth- | (% by mass) | | | | |
| Volatiles | ash | fur | ers | Fe₂O₃ | SiO₂ | Al₂O₃ | CaO | MgO |
| 15.8 | 4.3 | 0.61 | 79.29 | 13.84 | 43.09 | 27.57 | 4.95 | 1.54 |

TABLE 3
Component composition of dolomite ore (% by mass)

| CO₂ | SiO₂ | Al₂O₃ | CaO | MgO |
|---|---|---|---|---|
| 47.60 | 1.02 | 0.21 | 30.08 | 21.09 |

A binder (flour) was added to the mixture M in addition to the iron oxide-containing material and the carbonaceous reductant. Slag basicity-adjusting auxiliary materials, such as calcium carbonate (CaCO₃) serving as a CaO-supplying material and dolomite ore (mainly composed of CaCO₃.MgCO₃, and detailed component composition being shown in Table 3) serving as a CaO/MgO-supplying material, sodium carbonate (Na₂CO₃) as an alkali metal compound, sodium oxide (Na₂O), nepheline [composition: (Na,K)(Al,Si)O₄], lithium carbonate (Li₂CO₃), and so forth were added thereto, as needed, thereby affording a raw-material mixture (hereinafter, also referred to as a “mix”). Table 4 shows component compositions of the mixes.

TABLE 4

| Test | Component composition (% by mass) of mix | | | | | | | |
|---|---|---|---|---|---|---|---|---|
| example | Iron ore | Coal | Binder | CaCO₃ | Dolomite ore | Na₂CO₃ | Nepheline | Li₂CO₃ |
| a1 | 75.7 | 16.0 | 0.5 | 5.8 | — | — | 2.0 | — |
| a2 | 77.7 | 16.0 | 1.0 | 0.7 | 3.8 | 0.8 | — | — |
| a3 | 77.1 | 15.5 | 1.0 | 0.8 | 4.0 | 1.6 | — | — |
| a4 | 77.8 | 15.6 | 1.0 | 3.6 | 1.0 | 1.0 | — | — |
| a5 | 78.0 | 15.1 | 1.0 | 2.7 | 2.3 | 0.9 | — | — |
| a6 | 77.3 | 15.4 | 1.0 | 3.0 | 2.0 | 1.3 | — | — |
| a7 | 77.7 | 15.2 | 1.0 | 2.0 | 3.0 | 1.1 | — | — |
| a8 | 77.3 | 15.4 | 1.0 | 3.0 | 2.0 | 1.3 | — | — |
| a9 | 78.1 | 15.6 | 1.0 | 4.0 | — | 1.3 | — | — |
| a10 | 79.1 | 15.8 | 1.0 | 3.0 | 1.0 | 0.1 | — | — |
| a11 | 76.6 | 15.4 | 1.0 | 4.0 | — | 3.0 | — | — |
| a12 | 73.7 | 14.9 | 1.0 | 5.4 | — | 5.0 | — | — |
| a13 | 78.5 | 15.7 | 1.0 | 4.7 | — | — | — | 0.10 |
| a14 | 77.6 | 15.6 | 1.0 | 5.7 | — | — | — | 0.10 |
| a15 | 78.2 | 15.7 | 1.0 | 3.1 | — | — | — | 2.00 |
| a16 | 77.8 | 15.6 | 1.0 | 4.0 | — | — | — | 1.60 |
| a17 | 77.3 | 15.5 | 1.0 | 2.2 | 2.0 | — | — | 2.00 |
| a18 | 77.0 | 15.4 | 1.0 | 3.0 | 2.0 | — | — | 1.60 |
| a19 | 76.1 | 15.3 | 1.0 | 5.6 | — | — | — | 2.00 |
| a20 | 79.0 | 15.8 | 1.0 | 3.0 | 1.2 | — | — | 0.01 |
| a21 | 73.9 | 14.6 | 1.0 | — | 6.5 | — | — | 4.00 |
| a22 | 78.4 | 15.4 | 1.0 | 2.7 | 1.5 | 0.5 | — | 0.50 |
| a23 | 77.9 | 15.4 | 1.0 | 2.7 | 1.5 | 0.5 | — | 1.00 |
| a24 | 75.5 | 15.2 | 1.0 | 5.2 | 1.0 | 2.1 | — | — |
| a25 | 74.0 | 15.0 | 1.0 | 6.0 | — | — | — | 4.00 |
| a26 | 80.5 | 15.8 | 1.0 | 1.5 | 1.2 | — | — | 0.01 |
| a27 | 81.7 | 17.3 | 1.0 | — | — | — | — | — |
| a28 | 79.0 | 15.0 | 1.0 | 3.0 | 2.0 | — | — | — |
| a29 | 84.0 | 15.0 | 1.0 | — | — | — | — | — |
| a30 | 81.0 | 15.0 | 1.0 | 1.5 | 1.5 | — | — | — |
| a31 | 81.7 | 14.9 | 1.0 | 1.2 | 1.2 | — | — | — |
| a32 | 81.0 | 14.8 | 1.0 | 1.7 | 1.5 | — | — | — |
| a33 | 80.6 | 14.7 | 1.0 | 2.2 | 1.5 | — | — | — |
| a34 | 79.7 | 15.1 | 1.0 | 2.7 | 1.5 | — | — | — |

Each of the resulting mixes was formed into raw-material compacts in the form of pellets. The resulting raw-material compacts were charged into a small experimental thermal reduction furnace and subjected to thermal reduction. Coal (carbonaceous powder) having a component composition shown in Table 2 was arranged on a hearth to form a bed layer having a thickness of about 5 mm before the charging of the raw-material compacts. The temperature in the furnace was set to 1450° C.

Iron oxide in the raw-material compacts on the hearth of the thermal reduction furnace was reduced while being heated over about 10 to about 16 minutes in the furnace, with iron oxide maintained in a solid state. The resulting reduced iron was subjected to carburization with the remaining carbonaceous powder after reduction, thereby reducing the melting point and resulting in coalescence of reduced iron. Slag formed as a by-product at this time was partially or completely melted and coalesced. Thereby, the molten granular metallic iron was separated from the molten slag. Then molten granular metallic iron and the molten slag were cooled to their melting points (specifically, about 1100° C.) and solidified. Solid granular metallic iron and the solid slag were discharged from the furnace.

Tables 5 and 6 show component compositions of granular metallic iron and the slag in each test example. Furthermore, the basicity of the slag (((CaO)+(MgO))/(SiO₂)) was calculated from the CaO content, the MgO content, and the SiO₂ content of the slag in each test example. Tables 5 and 6 also show the slag basicity in each test example.

TABLE 5

| | Component composition | | | | | | | | | | | | | | | | Distri- | |
|---|---|---|---|---|---|---|---|---|---|---|---|---|---|---|---|---|---|---|
| | of granular metallic | | | | | | | | | | | | | | | | bution | Coa- |
| Test | iron (% by mass) | | | | | Component composition of slag (% by mass) | | | | | | | | | | | ratio of | lescing |
| example | C | Si | Mn | P | S | T. Fe | SiO₂ | CaO | Al₂O₃ | MgO | Na₂O | K₂O | Li₂O | P | S | Basicity | sulfur | ability |
| a1 | 3.28 | 0.15 | 0.14 | 0.034 | 0.058 | 0.91 | 32.38 | 23.87 | 13.63 | 21.95 | 1.38 | 0.33 | <0.01 | 0.004 | 0.598 | 1.42 | 10.31 | A |
| a2 | 3.77 | 0.21 | 0.08 | 0.022 | 0.058 | 0.96 | 30.04 | 30.93 | 10.50 | 17.19 | 0.36 | 0.04 | <0.01 | 0.005 | 1.220 | 1.60 | 21.03 | A |
| a3 | 3.45 | 0.14 | 0.08 | 0.022 | 0.048 | 1.06 | 28.91 | 31.76 | 10.11 | 17.42 | 0.78 | 0.04 | <0.01 | 0.008 | 1.230 | 1.70 | 25.63 | A |
| a4 | 3.29 | 0.07 | 0.08 | 0.018 | 0.046 | 0.57 | 28.77 | 44.49 | 9.73 | 9.12 | 1.00 | 0.03 | <0.01 | 0.028 | 1.180 | 1.86 | 25.65 | A |
| a5 | 2.92 | 0.07 | 0.04 | 0.049 | 0.059 | 1.06 | 29.84 | 46.66 | 9.47 | 10.17 | 0.64 | 0.02 | <0.01 | 0.145 | 1.400 | 1.90 | 23.73 | A |
| a6 | 3.52 | 0.06 | 0.08 | 0.019 | 0.037 | 0.70 | 28.78 | 43.81 | 9.65 | 12.47 | 0.74 | 0.02 | <0.01 | 0.012 | 1.270 | 1.96 | 34.32 | A |
| a7 | 2.80 | 0.06 | 0.03 | 0.045 | 0.077 | 1.41 | 30.06 | 43.34 | 9.28 | 12.53 | 1.43 | 0.03 | <0.01 | 0.195 | 1.190 | 1.86 | 15.45 | A |
| a8 | 3.49 | 0.07 | 0.10 | 0.020 | 0.036 | 0.77 | 28.58 | 43.55 | 9.65 | 12.27 | 1.46 | 0.02 | <0.01 | 0.007 | 1.340 | 1.95 | 37.22 | A |
| a9 | 3.21 | 0.09 | 0.07 | 0.018 | 0.042 | 1.09 | 28.33 | 41.13 | 9.79 | 6.99 | 2.01 | 0.05 | <0.01 | 0.011 | 1.089 | 1.70 | 25.93 | A |
| a10 | 3.18 | 0.07 | 0.04 | 0.022 | 0.048 | 1.18 | 32.43 | 42.23 | 10.15 | 11.56 | 0.34 | 0.06 | <0.01 | 0.009 | 1.210 | 1.66 | 25.21 | A |
| a11 | 3.41 | 0.13 | 0.09 | 0.028 | 0.039 | 0.81 | 24.12 | 35.60 | 8.27 | 6.00 | 2.69 | 0.04 | <0.01 | 0.020 | 1.310 | 1.72 | 33.59 | A |
| a12 | 3.11 | 0.06 | 0.08 | 0.031 | 0.025 | 0.92 | 22.58 | 44.44 | 8.45 | 5.24 | 5.02 | 0.03 | <0.01 | 0.070 | 1.299 | 2.20 | 51.96 | A |
| a13 | 3.56 | 0.07 | 0.05 | 0.020 | 0.050 | 0.95 | 28.06 | 46.71 | 9.40 | 6.59 | 0.05 | 0.06 | 0.40 | 0.004 | 0.595 | 1.90 | 11.90 | A |
| a14 | 2.92 | 0.06 | 0.06 | 0.020 | 0.045 | 1.12 | 25.39 | 49.90 | 8.51 | 5.15 | 0.07 | 0.08 | 0.37 | 0.006 | 0.952 | 2.17 | 21.16 | A |
| a15 | 2.94 | 0.08 | 0.07 | 0.040 | 0.045 | 0.89 | 29.83 | 35.13 | 10.29 | 7.13 | 0.03 | 0.03 | 9.09 | 0.005 | 0.709 | 1.42 | 15.76 | A |
| a16 | 2.98 | 0.07 | 0.03 | 0.030 | 0.008 | 1.12 | 28.33 | 41.23 | 9.79 | 6.99 | 0.04 | 0.05 | 6.15 | 0.007 | 0.990 | 1.70 | 123.75 | A |
| a17 | 3.56 | 0.06 | 0.06 | 0.020 | 0.011 | 1.32 | 27.33 | 34.17 | 9.37 | 12.94 | 0.09 | 0.07 | 7.44 | 0.009 | 1.920 | 1.72 | 174.55 | A |
| a18 | 4.08 | 0.06 | 0.10 | 0.021 | 0.013 | 1.43 | 23.71 | 34.35 | 7.81 | 9.44 | 0.05 | 0.04 | 5.73 | 0.013 | 1.180 | 1.85 | 90.77 | A |
| a19 | 3.58 | 0.08 | 0.08 | 0.030 | 0.007 | 1.19 | 23.94 | 47.18 | 8.31 | 6.25 | 0.06 | 0.07 | 6.59 | 0.007 | 1.220 | 2.23 | 174.29 | A |
| a20 | 3.41 | 0.09 | 0.09 | 0.040 | 0.043 | 1.25 | 32.15 | 42.95 | 11.05 | 12.22 | 0.07 | 0.07 | 0.05 | 0.008 | 0.710 | 1.72 | 16.51 | A |
| a21 | 3.31 | 0.09 | 0.09 | 0.040 | 0.006 | 1.11 | 20.2 | 24.21 | 6.7 | 21.8 | 0.02 | 0.02 | 11.80 | 0.009 | 1.852 | 2.28 | 308.67 | A |
| a22 | 3.26 | 0.17 | 0.05 | 0.042 | 0.036 | 0.79 | 29.34 | 39.43 | 10.06 | 11.86 | 1.23 | 0.04 | 2.01 | 0.009 | 1.591 | 1.75 | 44.19 | A |
| a23 | 3.98 | 0.12 | 0.06 | 0.031 | 0.022 | 0.93 | 28.12 | 37.95 | 9.65 | 11.39 | 1.64 | 0.05 | 4.02 | 0.011 | 1.826 | 1.75 | 83.00 | A |

TABLE 6

| | Component composition | | | | | | | | | | | | | | | | Distri- | |
|---|---|---|---|---|---|---|---|---|---|---|---|---|---|---|---|---|---|---|
| | of granular metallic | | | | | | | | | | | | | | | | bution | Coa- |
| Test | iron (% by mass) | | | | | Component composition of slag (% by mass) | | | | | | | | | | | ratio of | lescing |
| example | C | Si | Mn | P | S | T. Fe | SiO₂ | CaO | Al₂O₃ | MgO | Na₂O | K₂O | Li₂O | P | S | Basicity | sulfur | ability |
| a24 | — | — | — | — | — | — | — | — | — | — | — | — | — | — | — | — | — | C |
| a25 | — | — | — | — | — | — | — | — | — | — | — | — | — | — | — | — | — | C |
| a26 | 3.21 | 0.06 | 0.04 | 0.020 | 0.098 | 1.52 | 35.92 | 33.28 | 12.96 | 13.91 | 0.08 | 0.03 | <0.01 | 0.060 | 0.409 | 1.31 | 4.17 | A |
| a27 | 2.72 | 0.10 | 0.04 | 0.018 | 0.132 | 1.56 | 50.45 | 10.61 | 18.12 | 8.91 | 0.08 | 0.03 | <0.01 | 0.005 | 0.045 | 0.39 | 0.34 | A |
| a28 | 3.46 | 0.07 | 0.13 | 0.035 | 0.051 | 0.84 | 26.37 | 38.53 | 12.66 | 12.80 | 0.02 | 0.05 | <0.01 | 0.007 | 0.501 | 1.95 | 9.82 | B |
| a29 | 1.96 | 0.08 | 0.02 | 0.019 | 0.154 | 2.08 | 56.84 | 14.18 | 16.17 | 4.47 | 0.07 | 0.02 | <0.01 | 0.004 | 0.042 | 0.33 | 0.27 | A |
| a30 | 2.54 | 0.13 | 0.07 | 0.021 | 0.106 | 0.81 | 37.23 | 32.59 | 13.00 | 12.52 | 0.08 | 0.02 | <0.01 | 0.004 | 0.307 | 1.21 | 2.90 | A |
| a31 | 2.52 | 0.08 | 0.05 | 0.020 | 0.132 | 1.76 | 35.34 | 30.31 | 11.92 | 12.54 | 0.05 | 0.02 | <0.01 | 0.006 | 0.206 | 1.21 | 1.56 | A |
| a32 | 2.63 | 0.06 | 0.05 | 0.020 | 0.126 | 1.02 | 33.55 | 35.65 | 10.95 | 12.96 | 0.06 | 0.06 | <0.01 | 0.004 | 0.372 | 1.45 | 2.95 | A |
| a33 | 2.72 | 0.07 | 0.06 | 0.020 | 0.081 | 1.08 | 31.10 | 39.80 | 10.52 | 13.00 | 0.06 | 0.02 | <0.01 | 0.005 | 0.409 | 1.70 | 5.05 | A |
| a34 | 2.50 | 0.06 | 0.06 | 0.020 | 0.116 | 1.23 | 31.86 | 36.45 | 11.57 | 11.85 | 0.08 | 0.04 | <0.01 | 0.009 | 0.435 | 1.52 | 3.75 | A |

In each test example, the yield rate (Fe1/Fe0) was calculated from the ratio of “the mass of Fe (hereinafter, also referred to as “Fe1”) as granular metallic iron formed by coalescence” to “the mass of Fe (hereinafter, also referred to as “Fe0”) determined from composition calculation”. Coalescing ability in the test example with a yield rate exceeding 98% was evaluated as good (A). Coalescing ability in the test example with a yield rate of 98% or less was evaluated as poor (B). Tables 5 and 6 also show the evaluation results of the test examples. In Table 6, “coalescing ability (C)” indicates that granular metallic iron was not recovered because granular metallic iron was not separated from slag.

Furthermore, in each test example, the ratio of the sulfur content (S) of the slag to the sulfur content [S] of granular metallic iron (the distribution ratio of sulfur (S)/[S]) was calculated. Tables 5 and 6 also show the distribution ratio of sulfur in each test example.

In test example a1 shown in Table 5, an “alkali metal compound serving as a sodium compound and a potassium compound” was added as the alkali metal compound to the raw-material mixture. The alkali oxide content of the slag and the basicity of the slag satisfied expressions (2) to (4) described above. Note that the alkali metal compound used in test example a1 also corresponds to a “complex oxide having a melting point of 1400° C. or lower and containing at least one alkali metal” described below. In each of test examples a2 to a12 shown in Table 5, only a sodium compound was added as the alkali metal compound to the raw-material mixture. The alkali oxide content of the slag and the basicity of the slag satisfied expressions (2) and (4) described above. In each of test examples a13 to a21 shown in Table 5, only a lithium compound was added as the alkali metal compound to the raw-material mixture. The alkali oxide content of the slag and the basicity of the slag satisfied expressions (1) and (4) described above. In each of test examples a22 and a23 in Table 5, a sodium compound and a lithium compound were added as the alkali metal compound to the raw-material mixture. The alkali oxide content of the slag and the basicity of the slag satisfied expressions (1), (2), and (4) described above. All test examples a1 to a23 shown in Table 5 were within the range of this embodiment. MgO contents of the slags were in the range of 5% to 22% by mass.

Test example a26 shown in Table 6, although only a lithium compound was added as the alkali metal compound to the raw-material mixture, the alkali oxide content of the slag did not satisfy any of expressions (1) to (3). In each of test examples a27 to a34 shown in Table 6, an alkali metal compound was not added to the raw-material mixture. The alkali oxide content of the slag did not satisfy any of expressions (1) to (3). All test examples a26 to a34 shown in Table 6 were outside the range of this embodiment.

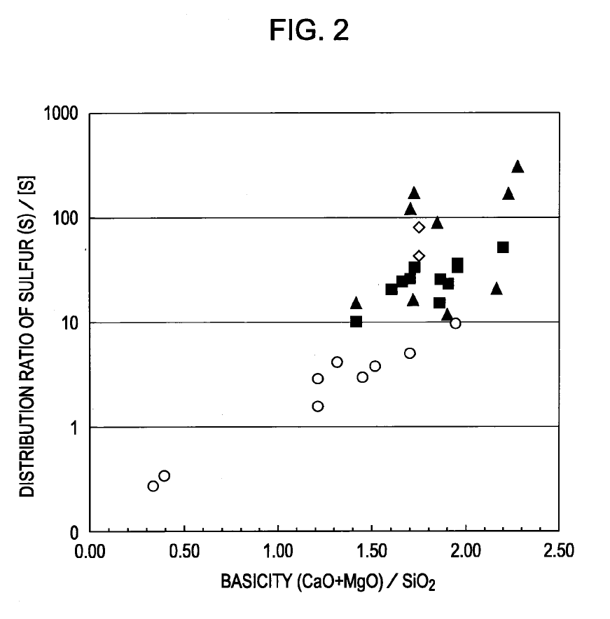

FIG. 2 shows the relationship between the basicity of each of the formed slags in test examples a1 to a23 and a26 to a34 and the distribution ratio of sulfur. In FIG. 2, the horizontal axis represents the basicity of the formed slag. The vertical axis represents the distribution ratio of sulfur.

In FIG. 2, closed squares correspond to test examples a1 to a12 shown in Table 5. Closed triangles correspond to test examples a13 to a21 shown in Table 5. Open rhombuses correspond to test examples a22 and a23 shown in Table 5. Open circles correspond to test examples a26 to a34 shown in Table 6.

Tables 5 and 6 clearly show that in order to achieve a sulfur content of granular metallic iron of 0.080% or less, the alkali oxide content of the slag and the slag basicity need to be within the range of this embodiment. It is thereby possible to ensure a distribution ratio of sulfur of 10 or more.

FIG. 2 clearly shows that the distribution ratio of sulfur, (S)/[S], is steeply increased with increasing slag basicity. In particular, a slag basicity exceeding 1.4 results in a significant increase in the distribution ratio of sulfur.

FIG. 2 clearly shows that the distribution ratio of sulfur, (S)/[S], is increased with increasing basicity, regardless of whether the alkali metal compound is added to the raw-material mixture or not. However, in each test example in which the alkali metal compound is added to the raw-material mixture and in which the alkali oxide content of the slag satisfies at least one of expressions (1) to (3) described above, the distribution ratio of sulfur, (S)/[S], is higher than those in the test examples in which the alkali oxide content of each slag does not satisfy expressions (1) to (3) described above.

In each test example in which no alkali metal compound was added to the raw-material mixture demonstrated that when the basicity of the final slag was increased to about 1.7, the melting point of the slag was increased, thus being liable to cause difficulty in allowing the molten slag to coalesce and cause inhibition of reduced iron. A large amount of small-grain granular metallic iron was formed, thereby causing difficulty in producing large-grain granular metallic iron in high yield.

In Example a, the slag basicity and the MgO content of the slag are adjusted by addition of dolomite ore serving as the CaO/MgO-supplying material. In each of the compositions of the mixes in Example a, the slag basicity and the MgO content of the slag can be controlled within the ranges of the basicity and the MgO content specified in this embodiment by controlling the dolomite ore content of the mix to be about 0% to 6.5% by mass.

As described above, Example a demonstrated that in the case where the iron oxide-containing material, the carbonaceous reductant, the alkali metal compound, and so forth were appropriately added to the raw-material mixture, the alkali oxide in the slag satisfied at least one of expressions (1) to (3) described above, and the basicity of the final slag determined from the CaO content, the MgO content, and the SiO₂ content satisfied expression (4), the distribution ratio of sulfur was set to 10 or more, and the sulfur content [S] of granular metallic iron was reduced to 0.080% or less even in a region where the basicity of the slag was 1.7 or more.

### Example b

An example of a method for manufacturing granular metallic iron with a “complex oxide having a melting point of 1400° C. or lower and containing at least one alkali metal” serving as the alkali metal compound will be described below.

Iron ore shown in Table 1 was used as an iron oxide-containing material. Coal shown in Table 2 was used as a carbonaceous reductant. These were mixed to form a mixture N.

A binder was added to the mixture N in addition to the iron oxide-containing material and the carbonaceous reductant. Slag basicity-adjusting auxiliary materials and an alkali metal compound (a complex oxide, a single oxide, or carbonate) were added thereto, as needed, thereby affording a raw-material mixture (mix).

Flour was added as the binder. As the slag basicity-adjusting auxiliary materials, calcium carbonate (CaCO₃) serving as a CaO-supplying material and dolomite ore, serving as a CaO/MgO-supplying material, shown in Table 3 were added.

Table 7 shows component compositions of the complex oxides and the single oxide. Types A to F shown in Table 7 are examples in which complex oxides are used as the alkali metal compounds. Type G shown in Table 7 is an example in which a single oxide (alkali oxide) is used as the alkali metal compound. Table 7 shows compositions when elements detected by analyzing the component compositions of the complex oxides and the single oxide using ICP spectrometry or atomic absorption spectrophotometry were calculated as oxides.

TABLE 7

| Component composition of | | | | | |
|---|---|---|---|---|---|
| complex oxide and single oxide | | | | | Melting |
| (% by mass) | | | | | point |
| Type | SiO₂ | CaO | Na₂O | Li₂O | (° C.) |
| A | 55.0 | — | — | 45.0 | 1024 |
| B | 59.1 | 24.8 | — | 16.1 | 1090 |
| C | 38.7 | 50.0 | — | 11.3 | 1050 |
| D | 50.9 | 31.6 | 17.5 | — | 1284 |
| E | 51.0 | 15.6 | 33.4 | — | 1200 |
| F | 50.0 | 43.0 | 7.0 | — | 1400 |
| G | — | — | — | 100 | 1570 |

Complex oxides of Types A to F shown in Table 7 were prepared by melting SiO₂, CaCO₃, Na₂CO₃, and Li₂CO₃ at 1500° C., maintaining the state for 1 to 2 hours, and performing pulverization in such a manner that the average grain size was 100 μm or less. Table 7 also shows melting points of the oxides.

The carbonate was an alkali metal compound, used together with the complex oxide, other than the complex oxide. Lithium carbonate (Li₂CO₃) was added as a lithium compound.

Table 8 shows component compositions of the mixes.

TABLE 8

| Test | Component composition (% by mass) of mix | | | | | | | |
|---|---|---|---|---|---|---|---|---|
| ex- | | | | | Oxide | | | |
| am- | Iron | | | Dolomite | | Con- | | Bind- |
| ple | ore | Coal | CaCO₃ | ore | Type | tent | Li₂CO₃ | er |
| b1 | 81.7 | 17.3 | — | — | — | — | — | 1 |
| b2 | 79 | 15 | 3.0 | 2 | — | — | — | 1 |
| b3 | 84 | 15 | — | — | — | — | — | 1 |
| b4 | 81 | 15 | 1.5 | 1.5 | — | — | — | 1 |
| b5 | 81.7 | 14.9 | 1.2 | 1.2 | — | — | — | 1 |
| b6 | 81 | 14.8 | 1.7 | 1.5 | — | — | — | 1 |
| b7 | 79.7 | 15.1 | 2.7 | 1.5 | — | — | — | 1 |
| b8 | 80.6 | 14.7 | 2.2 | 1.5 | — | — | — | 1 |
| b9 | 66 | 13.5 | 8.5 | 6 | A | 5 | — | 1 |
| b10 | 68.5 | 14 | 6.5 | 5 | A | 5 | — | 1 |
| b11 | 70.1 | 14.4 | 5.0 | 4.5 | A | 5 | — | 1 |
| b12 | 72.1 | 15.8 | 3.5 | 3.9 | B | 2 | 1.7 | 1 |
| b13 | 73.5 | 16.2 | 2.1 | 3.5 | C | 2 | 1.7 | 1 |
| b14 | 71 | 15.6 | 4.5 | 2.2 | C | 4 | 1.7 | 1 |
| b15 | 69.8 | 14.4 | 6.3 | 5.5 | B | 3 | — | 1 |
| b16 | 72.3 | 14.7 | 5.0 | 4 | B | 3 | — | 1 |
| b17 | 75 | 15.2 | 3.0 | 2.8 | B | 3 | — | 1 |
| b18 | 75.6 | 15.4 | 2.5 | 2.5 | B | 3 | — | 1 |
| b19 | 76.9 | 15.4 | 4.1 | 2.5 | B | 0.1 | — | 1 |
| b20 | 78.2 | 15.7 | 3.0 | 2 | B | 0.1 | — | 1 |
| b21 | 80 | 15.9 | 1.5 | 1.5 | B | 0.1 | — | 1 |
| b22 | 80.3 | 16.1 | 1.5 | 1 | B | 0.1 | — | 1 |
| b23 | 79.05 | 15.9 | 2.0 | 2 | B | 0.05 | — | 1 |
| b24 | 79.08 | 15.9 | 2.0 | 2 | B | 0.02 | — | 1 |
| b25 | 79.09 | 15.9 | 2.0 | 2 | B | 0.01 | — | 1 |
| b26 | 73.5 | 16.1 | 3.5 | 3.9 | D | 2 | — | 1 |
| b27 | 73.5 | 16.1 | 3.5 | 3.9 | E | 2 | — | 1 |
| b28 | 74 | 15.6 | 3.5 | 3.9 | F | 2 | — | 1 |
| b29 | 77.5 | 16.1 | 2.4 | 2 | G | 1 | — | 1 |

Each of the resulting mixes was formed into raw-material compacts in the form of pellets. The resulting raw-material compacts were charged into a small experimental thermal reduction furnace and subjected to thermal reduction. Coal (carbonaceous powder) having a component composition shown in Table 2 was arranged on a hearth to form a bed layer having a thickness of about 5 mm before the charging of the raw-material compacts. The temperature in the furnace was set to 1450° C.

Iron oxide in the raw-material compacts on the hearth of the thermal reduction furnace was reduced while being heated over about 10 to about 16 minutes in the furnace, with iron oxide maintained in a solid state. The resulting reduced iron was subjected to carburization with the remaining carbonaceous powder after reduction, thereby reducing the melting point and resulting in coalescence of reduced iron. Slag formed as a by-product at this time was partially or completely melted and coalesced. Thereby, the molten granular metallic iron was separated from the molten slag. Then molten granular metallic iron and the molten slag were cooled to their melting points (specifically, about 1100° C.) and solidified. Solid granular metallic iron and the solid slag were discharged from the furnace.

After the raw-material compacts were charged into the experimental thermal reduction furnace, the state in the thermal reduction furnace was visually observed. The time required to allow all compacts within the field of view to melt was measured. Table 9 shows the melting completion time measured in each test example. A melting completion time of 14 minutes or less was evaluated as acceptable.

TABLE 9

| | | Distribution ratio | | Melting completion | |
|---|---|---|---|---|---|
| Test | | of sulfur | | time | |
| example | Basicity | Value | Evaluation | (min) | Evaluation |
| b1 | 0.39 | 0.34 | Unacceptable | 9.5 | Acceptable |
| b2 | 1.95 | 9.59 | Unacceptable | 14.75 | Unacceptable |
| b3 | 0.33 | 0.27 | Unacceptable | 9.5 | Acceptable |
| b4 | 1.21 | 2.90 | Unacceptable | 10.75 | Acceptable |
| b5 | 1.21 | 1.56 | Unacceptable | 10.75 | Acceptable |
| b6 | 1.45 | 2.95 | Unacceptable | 12.00 | Acceptable |
| b7 | 1.70 | 5.05 | Unacceptable | 13.25 | Acceptable |
| b8 | 1.52 | 3.75 | Unacceptable | 12.50 | Acceptable |
| b9 | 1.95 | 1109.0 | Acceptable | 11.00 | Acceptable |
| b10 | 1.57 | 257.5 | Acceptable | 11.00 | Acceptable |
| b11 | 1.31 | 41.2 | Acceptable | 10.00 | Acceptable |
| b12 | 1.64 | 187.6 | Acceptable | 11.50 | Acceptable |
| b13 | 1.79 | 211.6 | Acceptable | 11.25 | Acceptable |
| b14 | 1.82 | 418.5 | Acceptable | 11.00 | Acceptable |
| b15 | 2.27 | 152.1 | Acceptable | 11.75 | Acceptable |
| b16 | 1.83 | 58.1 | Acceptable | 11.50 | Acceptable |
| b17 | 1.32 | 18.1 | Acceptable | 10.50 | Acceptable |
| b18 | 1.19 | 9.0 | Unacceptable | 10.25 | Acceptable |
| b19 | Not coalesced | | | | |
| b20 | 1.93 | 31.5 | Acceptable | 11.75 | Acceptable |
| b21 | 1.31 | 12.3 | Acceptable | 10.50 | Acceptable |
| b22 | 1.17 | 7.5 | Unacceptable | 10.25 | Acceptable |
| b23 | 1.64 | 19.7 | Acceptable | 10.50 | Acceptable |
| b24 | 1.65 | 12.5 | Acceptable | 10.50 | Acceptable |
| b25 | 1.65 | 6.7 | Unacceptable | 11.00 | Acceptable |
| b26 | 1.96 | 277.8 | Acceptable | 11.50 | Acceptable |
| b27 | 1.83 | 162.0 | Acceptable | 11.00 | Acceptable |
| b28 | 1.99 | 57.8 | Acceptable | 12.00 | Acceptable |
| b29 | 1.91 | 35.4 | Acceptable | 13.75 | Acceptable |

Table 10 shows component compositions of granular metallic iron and the slag in each test example. Furthermore, the basicity of the slag (((CaO)+(MgO))/(SiO₂)) was calculated from the CaO content, the MgO content, and the SiO₂ content of the slag in each test example. The slag basicity of each test example is shown in Table 9. In test example b19 shown in Table 10, the slag basicity was adjusted to be about 2.4, so that coalescence did not occur.

TABLE 10

| | Component composition | | | | | | | | | | | | | |
|---|---|---|---|---|---|---|---|---|---|---|---|---|---|---|
| | of granular metallic iron | | | | | | | | | | | | | |
| Test | (% by mass) | | | | | Component composition of slag (% by mass) | | | | | | | | |
| example | C | Si | Mn | P | S | T. Fe | SiO₂ | CaO | Al₂O₃ | MgO | Li₂O | Na₂O | P | S |
| b1 | 2.72 | 0.10 | 0.04 | 0.018 | 0.132 | 1.56 | 50.45 | 10.61 | 18.12 | 8.91 | <0.01 | | 0.005 | 0.045 |
| b2 | 3.36 | 0.07 | 0.13 | 0.035 | 0.071 | 0.84 | 26.37 | 38.53 | 12.66 | 12.80 | <0.01 | | 0.007 | 0.681 |
| b3 | 1.96 | 0.08 | 0.02 | 0.019 | 0.154 | 2.08 | 56.84 | 14.18 | 16.17 | 4.47 | <0.01 | | 0.004 | 0.042 |
| b4 | 2.54 | 0.13 | 0.07 | 0.021 | 0.106 | 0.81 | 37.23 | 32.59 | 13.00 | 12.52 | <0.01 | | 0.004 | 0.307 |
| b5 | 2.52 | 0.08 | 0.05 | 0.020 | 0.132 | 1.76 | 35.34 | 30.31 | 11.92 | 12.54 | <0.01 | | 0.006 | 0.206 |
| b6 | 2.63 | 0.06 | 0.05 | 0.020 | 0.126 | 1.02 | 33.55 | 35.65 | 10.95 | 12.96 | <0.01 | | 0.004 | 0.372 |
| b7 | 2.72 | 0.07 | 0.06 | 0.020 | 0.081 | 1.08 | 31.10 | 39.80 | 10.52 | 13.00 | <0.01 | | 0.005 | 0.409 |
| b8 | 2.50 | 0.06 | 0.06 | 0.020 | 0.116 | 1.23 | 31.86 | 36.45 | 11.57 | 11.85 | <0.01 | | 0.009 | 0.435 |
| b9 | 4.63 | 0.07 | 0.11 | 0.022 | 0.001 | 1.76 | 27.79 | 43.22 | 3.44 | 10.89 | 11.68 | | 0.008 | 1.109 |
| b10 | 4.51 | 0.08 | 0.10 | 0.032 | 0.004 | 2.45 | 31.10 | 38.29 | 3.88 | 10.43 | 12.98 | | 0.011 | 1.030 |
| b11 | 4.35 | 0.13 | 0.11 | 0.014 | 0.023 | 1.46 | 33.77 | 34.05 | 4.24 | 10.31 | 14.04 | | 0.033 | 0.947 |
| b12 | 4.73 | 0.09 | 0.11 | 0.022 | 0.005 | 1.88 | 28.58 | 36.49 | 5.85 | 10.31 | 7.17 | | 0.009 | 0.938 |
| b13 | 4.69 | 0.08 | 0.10 | 0.022 | 0.005 | 2.35 | 27.22 | 37.82 | 6.51 | 11.02 | 7.62 | | 0.010 | 1.058 |
| b14 | 4.68 | 0.05 | 0.11 | 0.014 | 0.002 | 1.56 | 28.31 | 45.41 | 5.16 | 6.22 | 7.77 | | 0.031 | 0.837 |
| b15 | 4.43 | 0.08 | 0.08 | 0.022 | 0.009 | 2.08 | 27.91 | 50.58 | 4.55 | 12.87 | 3.20 | | 0.022 | 1.369 |
| b16 | 4.31 | 0.13 | 0.10 | 0.022 | 0.019 | 2.32 | 31.88 | 46.72 | 5.24 | 11.52 | 3.63 | | 0.013 | 1.103 |
| b17 | 3.92 | 0.12 | 0.11 | 0.014 | 0.049 | 2.33 | 38.06 | 39.57 | 6.29 | 10.58 | 4.30 | | 0.028 | 0.886 |
| b18 | 3.57 | 0.13 | 0.11 | 0.022 | 0.059 | 1.98 | 39.97 | 37.35 | 6.63 | 10.28 | 4.51 | | 0.022 | 0.529 |
| b19 | Not coalesced | | | | | | | | | | | | | |
| b20 | 4.11 | 0.13 | 0.09 | 0.034 | 0.031 | 1.86 | 30.49 | 45.16 | 10.13 | 13.75 | 0.22 | | 0.023 | 0.977 |
| b21 | 4.01 | 0.12 | 0.11 | 0.022 | 0.049 | 2.22 | 37.57 | 35.23 | 12.44 | 14.17 | 0.27 | | 0.028 | 0.603 |
| b22 | 3.79 | 0.14 | 0.10 | 0.032 | 0.068 | 1.88 | 39.72 | 33.85 | 13.18 | 12.63 | 0.29 | | 0.020 | 0.510 |
| b23 | 3.83 | 0.08 | 0.08 | 0.014 | 0.043 | 2.13 | 33.51 | 39.78 | 11.30 | 15.02 | 0.12 | | 0.033 | 0.848 |
| b24 | 3.49 | 0.05 | 0.10 | 0.022 | 0.049 | 2.05 | 33.37 | 39.87 | 11.37 | 15.11 | 0.04 | | 0.011 | 0.613 |
| b25 | 3.33 | 0.07 | 0.11 | 0.014 | 0.083 | 2.14 | 33.32 | 39.89 | 11.39 | 15.14 | 0.02 | | 0.027 | 0.560 |
| b26 | 4.71 | 0.08 | 0.10 | 0.022 | 0.004 | 1.99 | 30.25 | 45.73 | 6.49 | 13.43 | | 4.01 | 0.026 | 1.111 |
| b27 | 4.58 | 0.07 | 0.08 | 0.014 | 0.005 | 2.01 | 30.27 | 42.10 | 6.49 | 13.43 | | 7.61 | 0.028 | 0.810 |
| b28 | 4.46 | 0.08 | 0.09 | 0.015 | 0.017 | 1.98 | 29.84 | 46.10 | 6.39 | 13.43 | | 7.61 | 0.025 | 0.983 |
| b29 | 3.68 | 0.08 | 0.03 | 0.040 | 0.028 | 1.12 | 26.70 | 39.66 | 9.36 | 11.50 | 12.15 | | 0.007 | 0.990 |

Furthermore, in each test example, the ratio of the sulfur content (S) of the slag to the sulfur content [S] of granular metallic iron (the distribution ratio of sulfur (S)/[S]) was calculated. Table 9 also shows the distribution ratio of sulfur in each test example.

In each of test examples b9 to b17, b20, b21, b23, b24, and b29 shown in Table 10, one or two lithium compounds were added as the alkali metal compound to the raw-material mixture. The alkali oxide content of the slag and the basicity of the slag satisfied expressions (1) and (4) described above. In each of test examples b9 to b17, b20, b21, b23, and b24 shown in Table 10, a complex oxide was added as the alkali metal compound. In test example b29, a single oxide was added as the alkali metal compound. In each of test examples b26 to b28 shown in Table 10, a sodium compound corresponding to a complex oxide was added as the alkali metal compound to the raw-material mixture. The alkali oxide content of the slag and the basicity of the slag satisfied expressions (2) and (4) described above. All test examples b9 to b17, b20, b21, b23, b24, and b26 to b29 shown in Table 10 were within the range of this embodiment. MgO contents of the slags were in the range of 5% to 22% by mass.

In each of test examples b1 to b8 shown in Table 10, an alkali metal compound was not added to the raw-material mixture. The alkali oxide content of the slag did not satisfy any of expressions (1) to (3). In each of test examples b18 and b22 shown in Table 10, a lithium compound was added as the alkali metal compound to the raw-material mixture. Although the alkali oxide content of the slag satisfied expression (1) described above, the slag basicity did not satisfy expression (4) described above. In test example b25 shown in Table 10, although a lithium compound was added as the alkali metal compound to the raw-material mixture, the alkali oxide content of the slag did not satisfy any of expressions (1) to (3) described above. All test examples b1 to b8, b18, b22, and b25 shown in Table 10 were outside the range of this embodiment.

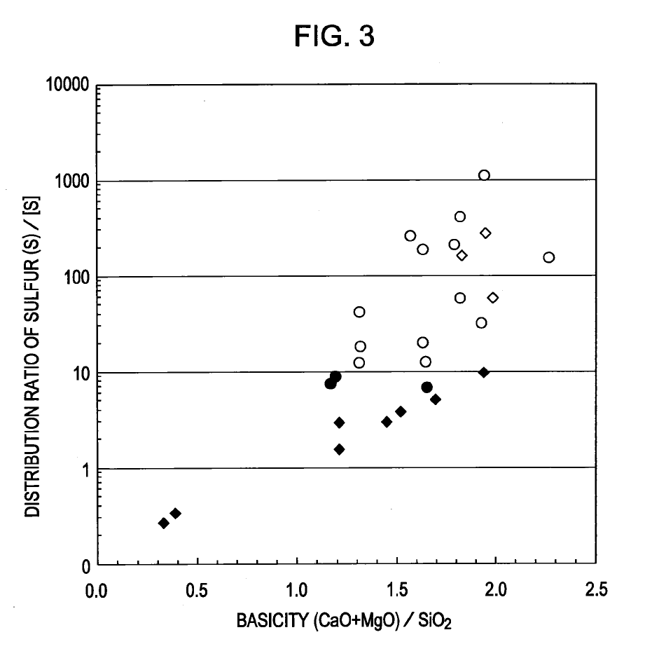

FIG. 3 shows the relationship between the basicity of each of the slags formed in test examples b1 to b18 and b20 to b29 and the distribution ratio of sulfur. In FIG. 3, the horizontal axis represents the basicity of the formed slag. The vertical axis represents the distribution ratio of sulfur.

In FIG. 3, closed rhombuses correspond to test examples b1 to b8. Open circles correspond to test examples b9 to b17, b20, b21, b23, and b24. Closed circles correspond to test examples b18, b22, and b25. Open rhombuses correspond to test examples b26 to b28.

As is apparent from Table 9, the melting completion time in each of test examples b9 to b17, b20, b21, b23, b24, and b26 to b29 that are within the range of this embodiment is evaluated as acceptable. The melting completion time in each of test examples b9 to b17, b20, b21, b23, b24, and b26 to b28 in which the “complex oxides each having a melting point of 1400° C. or lower and containing at least one alkali metal” are added as the alkali metal compounds is reduced to 13.5 minutes or less. Thus, in the case of adding the “complex oxide having a melting point of 1400° C. or lower and containing at least one alkali metal” as the alkali metal compound, it is possible to improve the productivity compared with the case of adding an “alkali metal compound, such as a single oxide or carbonate, other than the complex oxide”.

Tables 8 and 9 clearly show that in order to achieve a sulfur content of granular metallic iron of 0.05% or less, the alkali oxide content of the slag and the slag basicity need to be within the range of this embodiment. It is thereby possible to ensure a distribution ratio of sulfur of 10 or more.

FIG. 3 clearly shows that the distribution ratio of sulfur, (S)/[S], is steeply increased with increasing slag basicity.

Table 8 and FIG. 3 clearly show that the distribution ratio of sulfur, (S)/[S], is increased with increasing basicity, regardless of whether the alkali metal compound is added to the raw-material mixture or not. However, in each of test examples b9 to 17, b20, b21, b23, b24, and b26 to b28 in which the alkali metal compounds are added the raw-material mixtures and in which the alkali oxide content of each slag satisfies at least one of expressions (1) to (3) described above, the distribution ratio of sulfur, (S)/[S], is 10 or more. That is, the distribution ratio of sulfur, (S)/[S], is higher than those in test examples b1 to b8 in which the alkali oxide content of each slag does not satisfy expressions (1) to (3).

In Example b, the slag basicity and the MgO content of the slag are adjusted by addition of dolomite ore serving as the slag basicity-adjusting auxiliary material.

As described above, Example b demonstrated that in the case where the iron oxide-containing material, the carbonaceous reductant, the alkali metal compound, and so forth were appropriately added to the raw-material mixture, the alkali oxide in the slag satisfied at least one of expressions (1) to (3) described above, and the basicity of the final slag determined from the CaO content, the MgO content, and the SiO₂ content satisfied expression (4), the distribution ratio of sulfur was set to 10 or more (up to 1109.0), and the sulfur content [S] of granular metallic iron was reduced to 0.05% by mass or less even in a region where the basicity of the slag was 1.7 or more.

### Second Embodiment

A method for manufacturing granular metallic iron according to a second embodiment will be described.

The method for manufacturing granular metallic iron according to this embodiment includes the steps of charging an alkali metal compound and a raw-material mixture that contains an iron oxide-containing material and a carbonaceous reductant into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron.

The raw-material mixture or the alkali metal compound contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O, the alkali oxide satisfies at least one of expressions (1) to (3) described above, and the basicity of the slag satisfies expression (4) described above.

That is, the method is the same as the method for manufacturing granular metallic iron according to the first embodiment, except that the alkali metal compound is not contained in the raw-material mixture but is directly charged into the thermal reduction furnace.

In this embodiment, when the raw-material mixture and the alkali metal compound are charged into (added to) the thermal reduction furnace, the outer surface of the raw-material mixture comes into contact with the outer surface of the alkali metal compound. The same reaction as in the first embodiment proceeds in a contact portion by heat supplied from the thermal reduction furnace. Thus, it is inferred that in the case where the basicity of the slag formed as a by-product in manufacturing granular metallic iron is controlled so as to satisfy expression (4) described above and where the alkali oxide in the slag is controlled so as to satisfy at least one of expressions (1) to (3) described above, the melting point of the slag formed as a by-product is reduced, physical properties such as flowability of the slag are optimized, and the distribution ratio of sulfur, (S)/[S], for the slag as a by-product is maximized. Also in this embodiment, it is possible to manufacture granular metallic iron having a low sulfur content with good productivity.

A charging method of the alkali metal compound is not particularly limited. As a method for adding the alkali metal compound to the raw-material mixture, for example, the alkali metal compound may be charged together with a component of a bed layer. The alkali metal compound may be placed on a rotary hearth, in advance, independently of the component of the bed layer. Alternatively, the alkali metal compound may be charged simultaneously with the charging of the raw-material mixture or may be separately charged from above after the charging of the raw-material mixture. Furthermore, the plural charging methods may be used in combination. In any charging method, the effect of this embodiment is provided.

### Third Embodiment

A third embodiment of the present invention will be described below.

To achieve the object of the present invention, the inventors have conducted intensive studies on the basis of, in particular, the technique described in Patent Document 5 described above: (i) the adjustment of the slag basicity (((CaO)+(MgO))/(SiO₂)); and (ii) a reduction in the sulfur content of the reduced iron by adjusting the MgO content of the slag. In particular, in the third embodiment, environmental friendliness is a priority. Importance is placed on “providing a direct reduction iron-making process using a fluorite-free raw-material mixture”.

The inventors have found that from the viewpoint of “emphasis on environmental friendliness”, in the case where (a) the slag basicity is adjusted within substantially the same range as described in Patent Document 5 and where (b) the MgO content of the slag is adjusted in the “range of more than 13% by mass to 25% by mass or less”, which is outside the scope of Patent Document 5, reduced iron that has a low sulfur content and can be used as an iron source for electric furnaces and converters can be provided. The findings have led to the completion of the method for manufacturing granular metallic iron according to the third embodiment. That is, in the case where the raw-material mixture contains at least Fe, Ca, Mg, and Si as constituent elements in such a manner that the slag contains CaO, MgO, and SiO₂, the basicity of the slag satisfies expression (5) described above, and the MgO content of the slag satisfies expression (6) described above, it is possible to manufacture granular metallic iron having a low sulfur content with good productivity. The method for manufacturing granular metallic iron according to the third embodiment and the slag formed as a by-product by the method will be described in detail below.

Patent Document 5 and this embodiment share a common feature in that the sulfur content of reduced iron is reduced by adjusting the slag basicity and the MgO content of the slag. However, they differ in MgO content range mainly because of their objects. That is, in Patent Document 5, “a further reduction in sulfur content” is a top priority. The upper limit of the MgO content of the slag is set to 13% by mass in order to achieve a target level of Patent Document 5 (a distribution ratio of sulfur of 25 or more, and a sulfur content of metallic iron of 0.050% by mass or less). In contrast, in this embodiment, environmental friendliness is a top priority. The upper limit of the MgO content is set to 25% by mass from the viewpoint of providing a technique that can achieve a low sulfur content level (a distribution ratio of sulfur of 10 or more, and a sulfur content of metallic iron of 0.080% by mass or less) as an iron source sufficiently usable for converters although to a lesser degree than the target level of Patent Document 5.

For example, from the viewpoint of “fluorite-free”, in Patent Document 5, the addition of fluorite is recommended in the range in which “slag basicity≧1.7”. It is described that this prevents a significant reduction in the coalescing ability of reduced-iron fine particles and increases the yield. In contrast, in this embodiment, it is possible to manufacture reduced iron having a low sulfur content without using fluorite as long as the slag basicity is within the range of 1.5 to 2.2 (see Example c described below).

### [Basicity of Slag: 1.5 to 2.2]

The significance of the “basicity of the slag” in this embodiment is substantially the same as in Patent Document 5. That is, the slag basicity is a parameter contributing to an increase in the yield of granular metallic iron and a reduction in the proportion [S] of sulfur with which granular metallic iron is inevitably contaminated. Thus, the lower limit thereof is set to 1.5. A slag basicity of less than 1.5 causes a reduction in the desulfurization ability of the slag. The slag basicity in the practice of this embodiment is preferably 1.6 or more. However, a higher slag basicity causes an increase in the viscosity (flowability) of the slag, inhibiting the coalescence of reduced iron and thus leading to difficulty in providing granular metallic iron preferably having a roughly spherical shape. Furthermore, the yield of the granular metallic iron tends to be decreased. Thus, the upper limit of the slag basicity is determined to be 2.2. The slag basicity is preferably 2.1 or less and more preferably 2.0 or less. The slag basicity may be adjusted within the above range.

[Mgo Content of Slag: More than 13% by Mass and 25% by Mass or Less]

The significance of the “MgO content of the slag” in this embodiment is substantially the same as in Patent Document 5. That is, the content is set to achieve a satisfactory distribution ratio of sulfur, (S)/[S]. However, in Patent Document 5, “a significant reduction in sulfur content” is a top priority. The upper limit of the MgO content is determined to be 13% by mass from the viewpoint of ensuring a distribution ratio of sulfur of 25 or more. In contrast, in this embodiment, the lower limit of the MgO content is determined to be more than 13% by mass, and the upper limit thereof is determined to be 25% by mass from the viewpoint of achieving a low sulfur content level (a distribution ratio of sulfur of 10 or more, and a sulfur content of metallic iron of 0.080% by mass or less) as an iron source sufficiently usable for converters although to a lesser degree than the target level of Patent Document 5. According to this embodiment, it is possible to assuredly achieve the target level of this embodiment without using fluorite. A lower MgO content is preferred from the viewpoint of further reducing the sulfur content. The upper limit of the MgO content is set to 20% by mass.

The melting point of the slag formed as a by-product can be set to about 1350° C. to about 1550° C. by adjusting components of raw materials in such a manner that the formed slag satisfies expressions (5) and (6) described above. The temperature is lower than about 1550° C., which is a typical temperature during the operation of a moving-hearth thermal reduction furnace. Thus, in the case where the raw-material mixture containing components that have been adjusted in such a manner that the formed slag satisfies the requirement is heated in the moving-hearth thermal reduction furnace, slag-forming components are melted and coalesce to rapidly form slag. The rapid formation of the slag promotes coalescence of remaining metallic iron into granules, thereby resulting in improvement in the productivity of granular metallic iron.

The distribution ratio of sulfur, (S)/[S], between the final slag and final granular metallic iron is significantly improved by adjusting the components of the raw materials in such a manner that the formed slag satisfies expressions (5) and (6) described above. This results in a significant reduction in the sulfur content of granular metallic iron.

To adjust the melting point of the slag formed as a by-product to about 1350° C. to about 1550° C., the components of the raw materials may be adjusted in such a manner that the slag satisfies expressions (5) and (6) described above. Preferably, proportions of other oxides contained in the slag (e.g., the CaO content, the Al₂O₃ content, and the SiO₂ content) are also adjusted because the melting point of the slag is slightly affected by the proportions of these oxides. The CaO content may be set to about 20% to about 50% by mass. The Al₂O₃ content may be set to less than about 20% by mass. The SiO₂ content may be set to less than 40% by mass.

Expressions (5) and (6) described above can be satisfied by appropriately adjusting the addition amounts of the iron oxide-containing material and the carbonaceous reductant serving as raw materials. This is because the iron oxide-containing material and the carbonaceous reductant usually contain gangue components such as CaO, MgO, and SiO₂ and thus serve as a CaO-supplying material, a MgO-supplying material, and a SiO₂-supplying material (material that forms SiO₂ in the slag). Iron ore typical of iron oxide-containing materials and coal and coke typical of carbonaceous reductants are natural products. Hence, proportions of CaO, MgO, and SiO₂ are different, depending on the types thereof. It is thus difficult to uniformly determine the amounts of these materials added. It is preferred to appropriately adjust the addition amounts in consideration of the component composition of iron ore and so forth and the component composition of coal and so forth. In the case of charging a carbonaceous powder used as a component of a bed layer, the slag basicity and the MgO content of the slag may be controlled by adjusting the addition amounts of the iron oxide-containing material and the carbonaceous reductant in consideration of the component and amount of the carbonaceous powder.

The raw-material mixture used in this embodiment may contain “another MgO-supplying material” (an external additive in the light of the iron oxide-containing material and the carbonaceous reductant) other than the iron oxide-containing material and the carbonaceous reductant in addition to the iron oxide-containing material and the carbonaceous reductant. In this case, the amounts of the oxide-containing material and the carbonaceous reductant are adjusted in consideration of the component composition and the addition amount of the “another MgO-supplying material”, so that the slag basicity and the MgO content of the slag are controlled.

The type of “another MgO-supplying material” is not particularly limited. Examples thereof include a MgO powder, natural ore, Mg-containing materials extracted from seawater and so forth, and magnesium carbonate (MgCO₃).

Furthermore, the raw-material mixture used in this embodiment may contain “another CaO-supplying material” (an external additive in the light of the iron oxide-containing material and the carbonaceous reductant) other than the iron oxide-containing material and the carbonaceous reductant in addition to the iron oxide-containing material and the carbonaceous reductant. In this case, the amounts of the oxide-containing material and the carbonaceous reductant are adjusted in consideration of the component composition and the addition amount of the “another CaO-supplying material”, so that the slag basicity and the CaO content of the slag are controlled.

The type of “another CaO-supplying material” is not particularly limited. Examples thereof include quicklime (CaO) and calcium carbonate (CaCO₃).

An example of a material serving as the “another MgO-supplying material” and the “another CaO-supplying material” is dolomite ore. Dolomite ore may be added.

Preferably, fluorite is not added to the raw-material mixture from the viewpoint of “emphasis on environmental friendliness”. According to this embodiment, it is possible to sufficiently improve the desulfurization ability and the coalescing ability without adding fluorite. However, the addition of fluorite to the raw-material mixture can further improve the desulfurization ability and the coalescing ability.

A method for manufacturing granular metallic iron using a moving-hearth thermal reduction furnace according to this embodiment will be described in detail below with reference to FIG. 1. FIG. 1 shows a non-limiting example of a moving-hearth thermal reduction furnace suitably used in the manufacturing method of this embodiment.

FIG. 1 is a schematic explanatory view showing a structural example of a rotary hearth thermal reduction furnace A among moving-hearth thermal reduction furnaces. To show the internal structure of the furnace, the furnace is partially cut out to illustrate the inside.

A raw-material mixture 1 containing an iron oxide-containing material and a carbonaceous reductant is continuously fed onto a rotary hearth 4 of the rotary hearth thermal reduction furnace A through a material feed hopper 3. Iron ore, magnetite ore, and so forth are commonly used as the iron oxide-containing material. Coal, coke, and so forth are commonly used as the carbonaceous reductant.

The shape of the raw-material mixture 1 supplied is not particularly limited. Typically, a simple compact of the raw-material mixture containing the iron oxide-containing material and the carbonaceous reductant is supplied. Alternatively, a carbon material-containing compact of the raw-material mixture in the form of a pellet or briquette is supplied. A mixture in which the iron oxide-containing material, the carbonaceous reductant, and so forth are appropriately mixed may be supplied. Furthermore, granular carbonaceous powder 2 may be supplied together with the simple compact or the carbon material-containing compact.

In this embodiment, a material (e.g., a MgO-supplying material or a CaO-supplying material) other than the raw-material mixture may be charged, as needed.

A procedure for feeding the raw-material mixture 1 into the thermal reduction furnace A will be specifically described below. Preferably, the granular carbonaceous powder 2 is fed onto the rotary hearth 4 through the material feed hopper 3 to form a bed prior to the feed of the raw-material mixture 1, and then the raw-material mixture 1 is placed thereon.

An addition method of the MgO-supplying material and the CaO-supplying material that can be added in addition to the iron oxide-containing material and the carbonaceous reductant is not particularly limited. The following methods may be appropriately employed: For example, the MgO-supplying material and the CaO-supplying material may be added in a step of preparing the raw-material mixture. The MgO-supplying material and the CaO-supplying material may be placed on a rotary hearth, in advance, together with or independent of a component of the bed layer. Alternatively, the MgO-supplying material and the CaO-supplying material may be charged simultaneously with the charging of the raw-material mixture or may be separately charged from above after the charging of the raw-material mixture.

The raw-material mixture may contain a small amount of polysaccharide (e.g., starch from flour) as a binder.

FIG. 1 shows an example of one material feed hopper 3 that is used for both of the feed of the carbonaceous powder 2 and the feed of the raw-material mixture 1. Alternatively, the carbonaceous powder 2 and the raw-material mixture 1 may be separately charged using two or more hoppers.

Note that it is not always necessary to use the carbonaceous powder, serving as a component of the bed layer, placed on the hearth. The charging of the carbonaceous powder may be omitted. However, the arrangement of the carbonaceous powder, serving as the component of the bed layer, on the hearth results in a more efficient increase in reduction potential in the furnace, so that both effects of improving metallization ratio and reducing the sulfur content of metallic iron can be more effectively provided, which is preferred. To more assuredly provide such effects of the component of the bed layer, it is desirable to place a granular carbonaceous powder so as to form a layer having a thickness of about 2 mm or more. In the case where the carbonaceous powder is placed as the component of the bed layer in such a manner that the layer has a certain thickness, the bed layer serves as a buffer between the raw-material mixture and a hearth refractory or serves as a protector for protecting the hearth refractory from slag as a by-product, thereby serving to extend the life of the hearth refractory.

An excessively larger thickness of the bed layer, however, may disadvantageously cause inhibition of reduction by allowing the raw-material mixture to sink in the bed layer on the hearth. Thus, the thickness of the bed layer is preferably set to be about 7.5 mm or less.

The type of carbonaceous powder used as the component of the bed layer is not particularly limited. Crushed ordinary coal or coke may be used. Preferably, crushed ordinary coal or coke with a grain size that has been properly controlled may be used. In the case of using coal, anthracite, which has low flowability and does not expand or become sticky on the hearth, is suitable. The carbonaceous powder fed to form the bed preferably has a lower sulfur content than the carbonaceous reductant added to the raw-material mixture 1.

The rotary hearth 4 of the thermal reduction furnace A shown in FIG. 1 is rotated counterclockwise. The rotation speed of the rotary hearth 4 varies depending on the size and operation conditions of the thermal reduction furnace A. The rotary hearth typically has a cycle period of about 8 to about 16 minutes. A plurality of heating burners 5 are arranged on walls of a furnace body 8 of the thermal reduction furnace A. The hearth is supplied with heat resulting from combustion heat or radiant heat from the heating burners 5. The heating burners 5 may be arranged on a ceiling portion of the furnace.

The raw-material mixture 1 placed on the rotary hearth 4 constituted by a refractory material is heated by combustion heat or radiant heat from the heating burners 5 while being circumferentially moved on the rotary hearth 4 in the thermal reduction furnace A. Iron oxide in the raw-material mixture 1 is reduced while passing through a heating zone in the thermal reduction furnace A. Then reduced iron is subjected to carburization with the remaining carbonaceous reductant while being separated from molten slag formed as a by-product, and coalesces into granular metallic iron 10. The granular metallic iron 10 is solidified by cooling in a downstream zone of the rotary hearth 4 and then successively discharged from the hearth by a discharge device 6 such as a screw. At this time, the slag formed as a by-product is also discharged. The granular metallic iron 10 and the slag pass through a hopper 9 and then are separated into metallic iron and the slag with any separating means (e.g., a screen or a magnetic separator). In FIG. 1, reference numeral 7 denotes an exhaust gas duct.

In this embodiment, as described above, for the slag formed as a by-product by thermal reduction, the slag basicity and the MgO content of the slag are adjusted so as to satisfy expressions (5) and (6) described above, so that the melting point of the formed slag and the distribution ratio of sulfur, (S)/[S], are appropriately controlled, thereby efficiently assuredly manufacturing granular metallic iron having a low sulfur content.

### Example

A method for manufacturing granular metallic iron according to this embodiment will be described in further detail below by examples. The present invention is not limited to these examples described below. These examples may be properly modified within the scope of the purposes described above and below. All such modifications are included in the technical scope of this embodiment. In the following examples, the results of tests performed with a small experimental thermal reduction furnace are described.

### Example c

Iron ore shown in Table 11 was used as an iron oxide-containing material. Coal shown in Table 2 was used as a carbonaceous reductant. These were mixed to form a mixture. Table 11 shows the component composition of the iron ore.

TABLE 11
Component composition of iron ore (% by mass)

| T. Fe | FeO | SiO₂ | CaO | MgO | Al₂O₃ | S | P |
|---|---|---|---|---|---|---|---|
| 69.33 | 29.92 | 1.64 | 0.42 | 0.41 | 0.45 | 0.013 | 0.014 |

A binder was added to the mixture in addition to the iron oxide-containing material and the carbonaceous reductant. Slag basicity-adjusting auxiliary materials were added thereto, as needed, to afford a raw-material mixture (mix). As the binder, flour was added.

As the slag basicity-adjusting auxiliary materials, calcium carbonate (CaCO₃) serving as a CaO-supplying material and dolomite ore, serving as a CaO/MgO-supplying material, shown in Table 3 were added. Table 12 shows component compositions of the mixes.

TABLE 12

| Test | Component composition of mix (% by mass) | | | | | |
|---|---|---|---|---|---|---|
| example | Iron ore | Coal | Binder | MgO | CaCO₃ | Dolomite ore |
| c1 | 79.7 | 16.5 | 1.0 | | 0.8 | 2.0 |
| c2 | 79.1 | 16.3 | 1.0 | | 1.3 | 2.3 |
| c3 | 78.5 | 16.2 | 1.0 | | 1.8 | 2.5 |
| c4 | 80.0 | 15.0 | 1.0 | | 1.5 | 2.5 |
| c5 | 80.8 | 16.2 | 1.0 | 1.1 | | 0.9 |
| c6 | 80.6 | 16.1 | 1.0 | 0.6 | | 1.7 |
| c7 | 80.2 | 16.1 | 1.0 | 1.0 | | 1.7 |
| c8 | 81.7 | 17.3 | 1.0 | | | |
| c9 | 79.0 | 15.0 | 1.0 | | 3.0 | 2.0 |
| c10 | 84.0 | 15.0 | 1.0 | | | |
| c11 | 81.0 | 15.0 | 1.0 | | 1.5 | 1.5 |
| c12 | 81.7 | 14.9 | 1.0 | | 1.2 | 1.2 |

Each of the resulting mixes was formed into raw-material compacts in the form of pellets. The resulting raw-material compacts were charged into a small experimental thermal reduction furnace and subjected to thermal reduction. Coal (carbonaceous powder) having a component composition shown in Table 2 was arranged on a hearth to form a bed layer having a thickness of about 5 mm before the charging of the raw-material compacts. The temperature in the furnace was set to 1450° C.

Iron oxide in the raw-material compacts on the hearth of the thermal reduction furnace was reduced while being heated over about 10 to about 16 minutes in the furnace, with iron oxide maintained in a solid state. The resulting reduced iron was subjected to carburization with the remaining carbonaceous powder after reduction, thereby reducing the melting point and resulting in coalescence of reduced iron. Slag formed as a by-product at this time was partially or completely melted and coalesced. Thereby, the molten granular metallic iron was separated from the molten slag. Then molten granular metallic iron and the molten slag were cooled to their melting points (specifically, about 1100° C.) and solidified. Solid granular metallic iron and the solid slag were discharged from the furnace.

Table 13 shows component compositions of granular metallic iron and the slag in each test example. Furthermore, the basicity of the slag (((CaO)+(MgO))/(SiO₂)) was calculated from the CaO content, the MgO content, and the SiO₂ content of the slag in each test example. The slag basicity of each test example is also shown in Table 13.

TABLE 13

| Test | Component composition | | | | | | | | | | | | | | | | |
|---|---|---|---|---|---|---|---|---|---|---|---|---|---|---|---|---|---|
| ex- | of granular metallic | | | | | | | | | | | | Ba- | Distribution ratio | | | |
| am- | iron (% by mass) | | | | | Component composition of slag (% by mass) | | | | | | | sic- | of sulfur | | Yield | |
| ple | C | Si | Mn | P | S | T. Fe | SiO₂ | CaO | Al₂O₃ | MgO | P | S | ity | Value | Evaluation | % | Evaluation |
| c1 | 3.33 | 0.13 | 0.13 | 0.029 | 0.070 | 2.23 | 24.73 | 26.17 | 11.96 | 23.62 | 0.029 | 1.151 | 2.01 | 16.44 | Acceptable | 99.0 | Acceptable |
| c2 | 3.55 | 0.12 | 0.11 | 0.026 | 0.064 | 1.04 | 29.48 | 32.84 | 11.64 | 18.76 | 0.026 | 1.129 | 1.75 | 19.05 | Acceptable | 99.0 | Acceptable |
| c3 | 3.59 | 0.14 | 0.14 | 0.031 | 0.058 | 2.42 | 22.42 | 30.68 | 9.80 | 17.50 | 0.031 | 1.252 | 2.15 | 21.59 | Acceptable | 99.1 | Acceptable |
| c4 | 3.48 | 0.09 | 0.12 | 0.031 | 0.076 | 0.87 | 29.89 | 34.03 | 12.69 | 13.30 | 0.033 | 0.911 | 1.58 | 11.99 | Acceptable | 98.5 | Acceptable |
| c5 | 3.07 | 0.20 | 0.08 | 0.021 | 0.132 | 3.64 | 32.19 | 14.34 | 11.74 | 30.73 | 0.018 | 0.371 | 1.40 | 2.81 | Unacceptable | 62.0 | Unacceptable |
| c6 | 2.72 | 0.13 | 0.08 | 0.020 | 0.132 | 3.64 | 34.18 | 19.20 | 11.99 | 24.27 | 0.035 | 0.305 | 1.27 | 2.31 | Unacceptable | 99.2 | Acceptable |
| c7 | 2.65 | 0.19 | 0.08 | 0.020 | 0.089 | 3.08 | 31.41 | 17.47 | 10.90 | 30.06 | 0.019 | 0.524 | 1.51 | 5.88 | Unacceptable | 72.2 | Unacceptable |
| c8 | 2.72 | 0.10 | 0.04 | 0.018 | 0.132 | 1.56 | 50.45 | 10.61 | 18.12 | 8.91 | 0.005 | 0.045 | 0.39 | 0.34 | Unacceptable | 99.1 | Acceptable |
| c9 | 3.36 | 0.07 | 0.13 | 0.035 | 0.071 | 0.84 | 26.37 | 38.53 | 12.66 | 12.80 | 0.007 | 0.681 | 1.95 | 9.59 | Unacceptable | 99.2 | Acceptable |
| c10 | 1.96 | 0.08 | 0.02 | 0.019 | 0.154 | 2.08 | 56.84 | 14.18 | 16.17 | 4.47 | 0.004 | 0.042 | 0.33 | 0.27 | Unacceptable | 98.2 | Acceptable |
| c11 | 2.54 | 0.13 | 0.07 | 0.021 | 0.106 | 0.81 | 37.23 | 32.59 | 13.00 | 12.52 | 0.004 | 0.307 | 1.21 | 2.90 | Unacceptable | 99.3 | Acceptable |
| c12 | 2.52 | 0.08 | 0.05 | 0.020 | 0.132 | 1.76 | 35.34 | 30.31 | 11.92 | 12.54 | 0.006 | 0.206 | 1.21 | 1.56 | Unacceptable | 99.6 | Acceptable |

Furthermore, in each test example, the ratio of the sulfur content (S) of the slag to the sulfur content [S] of granular metallic iron (the distribution ratio of sulfur (S)/[S]) was calculated. Table 13 also shows the distribution ratio of sulfur in each test example.

In each of test examples c1 to c4 shown in Table 13, the slag basicity and the MgO content of the slag satisfied expressions (5) and (6) described above. All test examples c1 to c4 were within the range of this embodiment.

In each of test examples c5, c6, c8, and c10 to c12 shown in Table 13, the slag basicity did not satisfy expression (5). In each of test examples c7 and c9 shown in Table 13, although the slag basicity satisfied expression (5), the MgO content of the slag did not satisfy expression (6). All test examples c5 to c12 shown in Table 13 were outside the range of this embodiment.

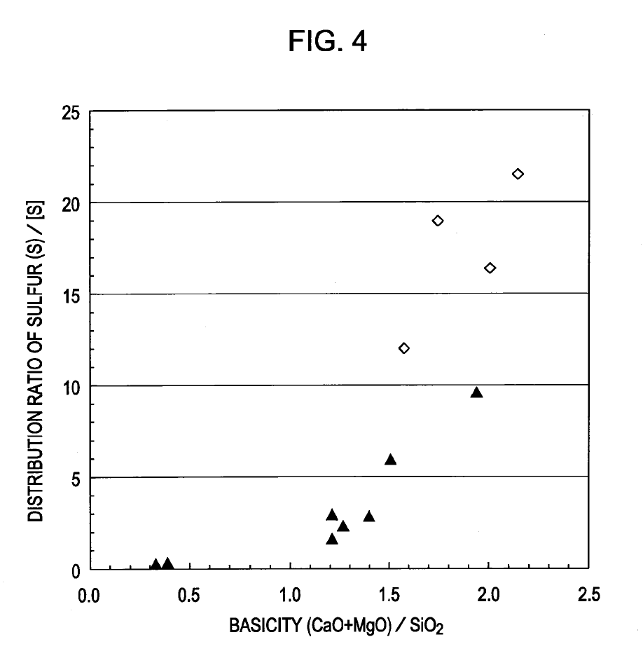

FIG. 4 shows the relationship between the basicity of each of the formed slags in test examples c1 to c12 and the distribution ratio of sulfur. In FIG. 4, the horizontal axis represents the basicity of the formed slag. The vertical axis represents the distribution ratio of sulfur. In FIG. 4, open rhombuses correspond to test examples c1 to c4 shown in Table 13. Closed triangles correspond to test examples c5 to c12 shown in Table 13.

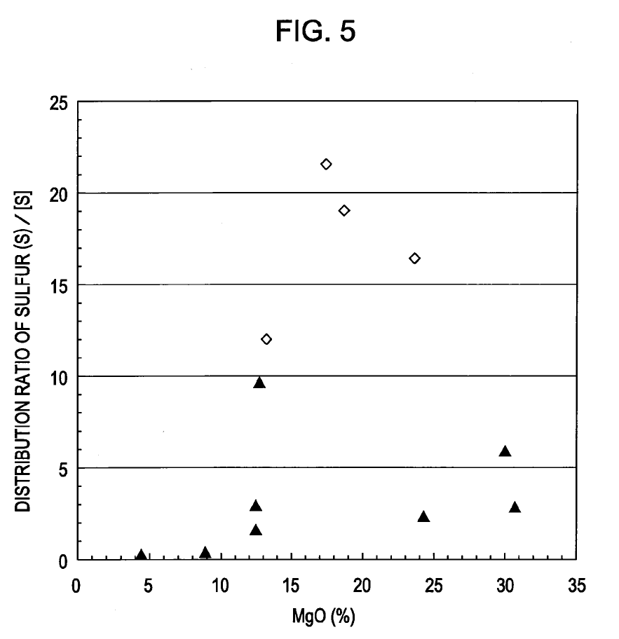

FIG. 5 shows the relationship between the MgO content of the formed slags test examples c1 to c12 and the distribution ratio of sulfur. In FIG. 5, the horizontal axis represents the MgO content (% by mass) of the formed slag. The vertical axis represents the distribution ratio of sulfur. In FIG. 5, open rhombuses correspond to test examples c1 to c4 shown in Table 13. Closed triangles correspond to test examples c5 to c12 shown in Table 13.

In each test example, the yield rate (Fe1/Fe0) was calculated from the ratio of “the mass of Fe (Fe1) as granular metallic iron formed by coalescence” to “the mass of Fe (Fe0) determined from composition calculation”. Coalescing ability in the test example with a yield rate exceeding 95% was evaluated as acceptable. Coalescing ability in the test example with a yield rate of less than 95% was evaluated as unacceptable. Table 13 also shows the evaluation results.

Table 13 and FIGS. 4 and 5 clearly show that in the case where the slag basicity and the MgO content are within the ranges of this embodiment (that is, the slag basicity and the MgO content satisfy expressions (5) and (6)), it is possible to ensure a distribution ratio of sulfur, (S)/[S], of 10 or more and achieve a sulfur content of granular metallic iron of 0.080% by mass or less.

Table 13 clearly shows that in the case where the MgO content is within the range of this embodiment, it is possible to increase the yield of granular metallic iron to 99.0% or more.

As described above, Example c demonstrated that in the case where the iron oxide-containing material, the carbonaceous reductant, and so forth were appropriately added to the raw-material mixture and where the slag basicity and the MgO content of the slag satisfied expressions (5) and (6), the distribution ratio of sulfur was set to 10 or more, and the sulfur content [S] of granular metallic iron was reduced to 0.080% by mass or less.

As described in detail above, according to an aspect of the present invention, a method for manufacturing granular metallic iron includes the steps of:

charging a raw-material mixture that contains an iron oxide-containing material, a carbonaceous reductant, and an alkali metal compound into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron,

in which the raw-material mixture contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O,

the alkali oxide satisfies at least one of expressions (1) to (3) described below, and the basicity of the slag satisfies expression (4) described below.

(Li₂O)≧0.03 (1)

(Na₂O)≧0.10 (2)

(K₂O)≧0.10 (3)

1.3≦((CaO)+(MgO))/(SiO₂)≦2.3 (4)

where in expressions (1) to (4), (Li₂O), (Na₂O), (K₂O), (CaO), (MgO), and (SiO₂) represent proportions (% by mass) of Li₂O, Na₂O, K₂O, CaO, MgO, and SiO₂ in the slag, respectively.

According to this method, the raw-material mixture contains at least Fe, Ca, Mg, Si, and the alkali metal as constituent elements in such a manner that the slag contains CaO, MgO, SiO₂, and the alkali oxide, the alkali oxide is at least one selected from Li₂O, Na₂O, and K₂O, the alkali oxide satisfies at least one of expressions (1) to (3) described above, and the basicity of the slag satisfies expression (4) described above. Thus, even in the case of using a carbonaceous reductant, such as coal or coke, having a high sulfur content, it is possible to reduce the proportion of sulfur with which granular metallic iron is contaminated even in a region where the basicity of the slag was 1.7 or more. It is possible to manufacture granular metallic iron having a sulfur content of 0.080% by mass or less with a yield rate exceeding 98%, i.e., it is possible to manufacture granular metallic iron having a reduced sulfur content with high productivity.

In this manufacturing method, the raw-material mixture may contain, for example, at least one compound selected from Na₂O and sodium carbonate, at least one compound selected from K₂O and potassium carbonate, at least one compound selected from Li₂O and lithium carbonate, or nepheline as the alkali metal compound.

In this case, preferably, the raw-material mixture further contains a complex oxide as the alkali metal compound, the complex oxide having a melting point of 1400° C. or lower and containing at least one alkali metal. The incorporation of the complex oxide, serving as the alkali metal compound, having a melting point of 1400° C. or lower and containing at least one alkali metal in addition to the alkali oxide and the alkali metal carbonate results in a further reduction in the sulfur content of granular metallic iron.

In this manufacturing method, the alkali metal compound is preferably a complex oxide having a melting point of 1400° C. or lower and containing at least one alkali metal. According to this method, the raw-material mixture contains the complex oxide having a melting point of 1400° C. or lower and containing at least one alkali metal. Thus, in the case of heating the raw-material mixture in the thermal reduction furnace, the complex oxide is readily melted to rapidly form slag. As a result, it is possible to melt the raw-material mixture in 13.5 minutes or less, thereby further improving the productivity.

In this manufacturing method, the slag preferably has a MgO content of 5% to 22% by mass. Since the slag has a MgO content of 5% to 22% by mass, it is possible to maintain the coalescing ability of reduced iron particles at a high level even when operation is performed at a high slag basicity. It is thus possible to manufacture large-grain metallic iron in high yield.

In this manufacturing method, preferably, the raw-material mixture further contains at least one compound selected from dolomite ore, MgO, and magnesium carbonate, or at least one compound selected from CaO and calcium carbonate. Iron ore added as the iron oxide-containing material and coal or coke added as the carbonaceous reductant are natural products. Hence, the CaO content and the MgO content vary depending on the types thereof. According to this method, dolomite ore, MgO, magnesium carbonate, CaO, or calcium carbonate is added to the raw-material mixture in response to variations in the CaO content and the MgO content of the iron oxide-containing material and the carbonaceous reductant, thereby adjusting the CaO content and the MgO content of the slag and the slag basicity. It is thus possible to manufacture granular metallic iron having a reduced sulfur content with good productivity.

According to another aspect of the present invention, a method for manufacturing granular metallic iron includes the steps of:

charging an alkali metal compound and a raw-material mixture that contains an iron oxide-containing material and a carbonaceous reductant into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron,

in which the raw-material mixture or the alkali metal compound contains at least Fe, Ca, Mg, Si, and an alkali metal as constituent elements in such a manner that the slag contains CaO, MgO, SiO₂, and an alkali oxide, the alkali oxide is at least one selected from Li₂O, Na₂O, and K₂O,

the alkali oxide satisfies at least one of expressions (1) to (3) described below, and the basicity of the slag satisfies expression (4) described below.

(Li₂O)≧0.03 (1)

(Na₂O)≧0.10 (2)

(K₂O)≧0.10 (3)

1.3≦((CaO)+(MgO))/(SiO₂)≦2.3 (4)

(where in expressions (1) to (4), (Li₂O), (Na₂O), (K₂O), (CaO), (MgO), and (SiO₂) represent proportions (% by mass) of Li₂O, Na₂O, K₂O, CaO, MgO, and SiO₂ in the slag, respectively).

According to this method, the raw-material mixture or the alkali metal compound contains at least Fe, Ca, Mg, Si, and the alkali metal as constituent elements in such a manner that the slag contains CaO, MgO, SiO₂, and the alkali oxide, the alkali oxide is at least one selected from Li₂O, Na₂O, and K₂O, the alkali oxide satisfies at least one of expressions (1) to (3) described above, and the basicity of the slag satisfies expression (4) described above. It is thus possible to manufacture granular metallic iron having a reduced sulfur content with good productivity.

According to another aspect of the present invention, a method for manufacturing granular metallic iron includes the steps of charging a raw-material mixture that contains an iron oxide-containing material and a carbonaceous reductant into a thermal reduction furnace, heating the raw-material mixture and reducing iron oxide in the iron oxide-containing material by the carbonaceous reductant to form metallic iron and slag as a by-product, causing metallic iron to coalesce into granules while separating metallic iron from slag, and cooling and solidifying metallic iron, in which the raw-material mixture contains at least contains at least Fe, Ca, Mg, and Si as constituent elements in such a manner that the slag contains CaO, MgO, and SiO₂, the basicity of the slag satisfies expression (5) described below, and the MgO content of the slag satisfies expression (6) described below.

1.5≦((CaO)+(MgO))/(SiO₂)≦2.2 (5)

13<(MgO)≦25 (6)

where in expressions (5) and (6), (CaO), (MgO), and (SiO₂) represent proportions (% by mass) of CaO, MgO, and SiO₂ in the slag, respectively.

According to this method, the slag contains CaO, MgO, and SiO₂, the basicity of the slag satisfies expression (5) described above, and the MgO content of the slag satisfies expression (6) described above. It is thus possible to reduce the proportion of sulfur with which granular metallic iron is contaminated even in the region in which the slag basicity is 1.7 or more. It is possible to manufacture granular metallic iron having a sulfur content of 0.080% by mass or less with a yield rate exceeding 95%, i.e., it is possible to manufacture granular metallic iron having reduced sulfur content with high productivity.

In this manufacturing method, preferably, the raw-material mixture further contains at least one compound selected from dolomite ore, MgO, and magnesium carbonate, or at least one compound selected from CaO and calcium carbonate. Iron ore added as the iron oxide-containing material and coal or coke added as the carbonaceous reductant are natural products. Hence, the CaO content and the MgO content vary depending on the types thereof. According to this method, dolomite ore, MgO, magnesium carbonate, CaO, or calcium carbonate is added to the raw-material mixture in response to variations in the CaO content and the MgO content of the iron oxide-containing material and the carbonaceous reductant, thereby adjusting the CaO content and the MgO content of the slag and the slag basicity. It is thus possible to manufacture granular metallic iron having a reduced sulfur content with good productivity.

According to another aspect of the present invention, slag formed as a by-product by any one of the manufacturing methods described above. The slag formed as a by-product by the manufacturing method has a high alkali oxide content or a high MgO content compared with conventional slag. Thus, analysis of the component composition of slag reveals whether the slag is manufactured by the method for manufacturing granular metallic iron according to the present invention or not.

### INDUSTRIAL APPLICABILITY

It is possible to manufacture granular metallic iron having a reduced sulfur content with good productivity by the method for manufacturing granular metallic iron of the present invention.

1. A method for manufacturing granular metallic iron, comprising:
charging a raw-material mixture that contains an iron oxide-containing material, a carbonaceous reductant, and an alkali metal compound into a thermal reduction furnace;
heating the raw-material mixture and reducing iron oxide in the iron oxide-containing material by the carbonaceous reductant to form metallic iron and slag as a by-product;
causing metallic iron to coalesce into granules while separating metallic iron from slag; and
cooling and solidifying metallic iron,
wherein the raw-material mixture contains at least Fe, Ca, Mg, Si, and an alkali metal as constituent elements in such a manner that
the slag contains CaO, MgO, SiO₂, and an alkali oxide,
the alkali oxide is at least one selected from Li₂O, Na₂O, and K₂O,
the alkali oxide satisfies at least one of expressions (1) to (3) described below, and
the basicity of the slag satisfies expression (4) described below,
(Li₂O)≧0.03 (1)
(Na₂O)≧0.10 (2)
(K₂O)≧0.10 (3)
1.3≦((CaO)+(MgO))/(SiO₂)≦2.3 (4)
where in expressions (1) to (4), (Li₂O), (Na₂O), (K₂O), (CaO), (MgO), and (SiO₂) represent proportions (% by mass) of Li₂O, Na₂O, K₂O, CaO, MgO, and SiO₂ in the slag, respectively.

2. The method according to claim 1, wherein the raw-material mixture contains at least one compound selected from Na₂O and sodium carbonate as the alkali metal compound.

3. The method according to claim 1, wherein the raw-material mixture contains at least one compound selected from K₂O and potassium carbonate as the alkali metal compound.

4. The method according to claim 1, wherein the raw-material mixture contains at least one compound selected from Li₂O and lithium carbonate as the alkali metal compound.

5. The method according to claim 1, wherein the raw-material mixture contains nepheline as the alkali metal compound.

6. The method according to claim 1, wherein the alkali metal compound is a complex oxide having a melting point of 1400° C. or lower and containing at least one alkali metal.

7. The method according to claim 2, wherein the raw-material mixture contains a complex oxide as the alkali metal compound, the complex oxide having a melting point of 1400° C. or lower and containing at least one alkali metal.

8. A method for manufacturing granular metallic iron, comprising:
charging an alkali metal compound and a raw-material mixture that contains an iron oxide-containing material and a carbonaceous reductant into a thermal reduction furnace;
heating the raw-material mixture and reducing iron oxide in the iron oxide-containing material by the carbonaceous reductant to form metallic iron and slag as a by-product;
causing metallic iron to coalesce into granules while separating metallic iron from slag; and
cooling and solidifying metallic iron,
wherein the raw-material mixture or the alkali metal compound contains at least Fe, Ca, Mg, Si, and an alkali metal as constituent elements in such a manner that
the slag contains CaO, MgO, SiO₂, and an alkali oxide,
the alkali oxide is at least one selected from Li₂O, Na₂O, and K₂O,
the alkali oxide satisfies at least one of expressions (1) to (3) described below, and
the basicity of the slag satisfies expression (4) described below,
(Li₂O)≧0.03 (1)
(Na₂O)≧0.10 (2)
(K₂O)≧0.10 (3)
1.3≦((CaO)+(MgO))/(SiO₂)≦2.3 (4).

9. The method according to claim 1, wherein the slag has a MgO content of 5% to 22% by mass.

10. The method according to claim 1, wherein the raw-material mixture further contains dolomite ore.

11. The method according to claim 1, wherein the raw-material mixture further contains at least one compound selected from MgO and magnesium carbonate.

12. The method according to claim 1, wherein the raw-material mixture further contains at least one compound selected from CaO and calcium carbonate.

13. A method for manufacturing granular metallic iron, comprising:
charging a raw-material mixture that contains an iron oxide-containing material and a carbonaceous reductant into a thermal reduction furnace;
heating the raw-material mixture and reducing iron oxide in the iron oxide-containing material by the carbonaceous reductant to form metallic iron and slag as a by-product;
causing metallic iron to coalesce into granules while separating metallic iron from slag; and
cooling and solidifying metallic iron,
wherein the raw-material mixture contains at least Fe, Ca, Mg, and Si as constituent elements in such a manner that
the slag contains CaO, MgO, and SiO₂,
the basicity of the slag satisfies expression (5) described below, and
the MgO content of the slag satisfies expression (6) described below,
1.5≦((CaO)+(MgO))/(SiO₂)≦2.2 (5)
13<(MgO)≦25 (6)
where in expressions (5) and (6), (CaO), (MgO), and (SiO₂) represent proportions (% by mass) of CaO, MgO, and SiO₂ in the slag, respectively.

14. The method according to claim 13, wherein the raw-material mixture further contains dolomite ore.

15. The method according to claim 13, wherein the raw-material mixture further contains at least one compound selected from MgO and magnesium carbonate.

16. The method according to claim 13, wherein the raw-material mixture further contains at least one compound selected from CaO and calcium carbonate.

17. Slag formed as a by-product by the method according to claim 1.
